(19) United States
(12) Patent Application Publication
(10) Pub. No.: US 2002/0138394 A1
(43) Pub. Date: Sep. 26, 2002

(54) Matrix method and system for maintenance services acquisition

(76) Inventor: Vincent F. Elliott, Baltimore, MD (US)

Correspondence Address: Morton J. Rosenberg, Esq., Rosenberg, Klein & Lee, Suite 101, 3458 Ellicott Center Drive, Ellicott City, MD, 21043, US

(21) Appl. No.: 09/777,830

(22) Filed: Feb. 7, 2001

(51) Int. Cl. G06F 17/60

(52) U.S. Cl. 705/37

(57) ABSTRACT

A matrix driven maintenance, repair and operation services system and method of doing business in the maintenance, repair and operation industry for acquisition of these services is based on software installed in a computer accessed by a buyer of maintenance, repair and operation services. Upon visiting a specific site through an on-line connection, the buyer supplies the computer with specific buyer's information which is processed and calculated in view of proprietary information stored in the processor for generating a request for proposal which is further transmitted to the buyer of maintenance, repair and operation services. Upon receiving the request for proposal, the buyer may contact providers either directly or through an on-line connection in which case the processor transmits the request of proposal to a plurality of providers and receives from them their proposals which are further processed within the computer and the results of the processing of the bidding information are transmitted to the buyer of maintenance, repair and operation services for decision making. The matrix driven computerized system and method of doing business in maintenance, repair and operation services industry permits construction of and request for proposals of maintenance, repair and operation services in a time and cost efficient manner.

### FIELD OF THE INVENTION

The present invention relates to the building maintenance service industry and more particularly, to maintenance, repair and operation services such as janitorial service acquisition processes. This invention is further directed to a matrix method and system for electronically generating a request for proposal for maintenance, repair and operation services.

More particularly, the present invention relates to a computerized system coupled through a communication link to a remote buyer of maintenance, repair and operation services with the purpose of requesting and receiving specific buyer's data in order to generate a request for proposal upon processing the received specific buyer's data and in combination with standard maintenance, repair and operation parameters (available either from the buyer of maintenance, repair and operation services or pre-stored in the computer memory). The generated request for proposal of maintenance, repair and operation services is further transmitted to the buyer of such services for his/her review and for further use by the buyer of these services from maintenance, repair and operation service providers.

Further, the present invention relates to a method of doing business in the maintenance, repair and operation services industry where a request for proposal of maintenance, repair and operation services is generated electronically by a computer upon receiving specific data from a remotely located buyer of the services (where specific data is processed in the computer in conjunction with standard maintenance, repair and operation parameters to calculate the buyer's requirements), and wherein the generated request for proposal may be further transmitted from the computer to websites of potential providers of maintenance, repair and operation services which, in response to the request of a proposal, submit their bids for the buyer's consideration.

### BACKGROUND OF THE INVENTION

In the maintenance, repair and operation services industry, a buyer of these services constructs a request for proposal of maintenance, repair and operation services which includes the scope of work to be accomplished, the details of a building to be cleaned, the breakdown of the building space into specific areas, such as offices vs. conference rooms vs. rest rooms vs. hallways, etc., type of floor covering, level of cleanness required, frequency of cleaning work, labor hours required, overall performance goal for the space to be cleaned, etc. This has, in the past, taken about 3-8 weeks by a team of people on the buyer's side to create a fully documented request for proposal. The request for proposal, after being constructed, is put into the marketplace which is usually held at a conference where contractors (maintenance, repair and operation services providers) gather to participate in the bidding process.

At the conference, the buyer explains to contractors the scope of services required, as well as the buyer's requirements for services costs. Responsive to the request for proposal of maintenance, repair and operation services, contractors submit their proposals approximately 2-3 weeks later, which has previously been the time needed to evaluate the buyer's requirements and capability of the maintenance, repair and operation services provider to meet the buyer's requirement. The proposals received from the providers are evaluated by the buyer, and if a decision is made by the buyer to hire a certain contractor, final contract negotiations are then conducted between the buyer and the selected contractor leading to a signed contract.

This typical process of acquisition of maintenance, repair and operation services has taken approximately from several weeks to several months, which is not only timewise unsatisfactory, but is also excessively cost consuming since it involves teams of people on both the buyer's and contractor's sides for preparation of a request for proposal, preparation of the proposal, evaluation of the proposal and rather intensive and time consuming negotiating processes between the buyer and the contractor. It is therefore extremely essential in the maintenance, repair and operation services industry to decrease time and cost consumption of the process of acquisition of maintenance, repair and operation services which is beneficial to both the contractor and buyer in general, and is important in the e-Commerce marketplace. The subject invention provides for computer on-line requesting, bidding and evaluation of proposals, bids and contracts which brings together a large group of interested parties to promote contract completion in a minimal amount of time.

### SUMMARY OF THE INVENTION

It is an object of the present invention to provide a matrix method and system for maintenance, repair and operation services acquisition processes which allows generating a request for proposal for maintenance, repair and operation services in a time effective manner.

It is a further object of the present invention to provide a computerized system capable of automatically generating a request for proposal for maintenance, repair and operation services upon the buyer's request and upon receiving specific buyer's data.

It is another object of the present invention to provide a matrix type method of doing business in the maintenance, repair and operation services industry in such a manner that a buyer of maintenance, repair and operation services visits through the Internet a predetermined computer web site, inputs specific buyer's data into the computer upon request, and receives from an on-line connection a complete request for proposal based on processed specific buyer's data and standard maintenance, repair and operation parameters which the buyer of such service can further use in pursuit of acquiring maintenance, repair and operation services.

It is an object of the present invention to provide a method of doing business in the maintenance, repair and operation services industry wherein the buyer may communicate with a plurality of maintenance, repair and operation services providers through a computer on-line connection which generates the buyer's request for proposal of maintenance, repair and operation services based on information provided by the buyer. The computer transmits the generated request for proposal to providers generally through the Internet, in order that the maintenance, repair and operation services providers may respond with their bidding information transmitted through the computer on-line connection.

Viewing another aspect of the subject system, the present invention is directed to a maintenance, repair and operation services system which comprises a processor coupled to a remote buyer of maintenance, repair and operation services. The processor includes a matrix of memory blocks storing standard maintenance, repair and operation parameters such as statistics data related to the buyer's building to be cleaned, local labor rates, cost for uniforms, equipment, supplies, paper, overhead expenses, profit mark-ups, etc. The processor further includes means for requesting and receiving through the communication link with the remote buyer, specific buyer's data.

The specific buyer data includes but is not limited to the name of the buyer, address of the building, building details, the industry within which the building is affiliated, square footage of the building, square footage of the area to be cleaned, breakdown for each type of space in the building, type of floor covering, level of cleaning, frequency of cleaning, etc. An essential portion of the specific buyer's data includes labor rates within the building, either for routine and non-routine labor.

Further, the processor includes means for processing the specific buyer's data in the processor means and calculating buyer's requirements responsive to the specific buyer's data input and in view of the standard maintenance, repair and operation parameters in accordance with specific mathematical algorithms.

The processor also includes means for generating buyer's request for proposal and means for transmitting the generated buyer's request for proposal to the buyer.

The processor may be connected not only to the remote buyer, but optionally may also be connected through the on-line connection to remote maintenance, repair and operation services providers to which the generated request for proposal (after approval of the buyer) is transmitted. Thus inviting other contractors to submit their proposals. The proposal information thus received at the processor is further processed in a timely fashion.

The present invention is also a matrix method for generating a request for proposal for maintenance, repair and operation services which comprises the steps of:

coupling the processor to a remote buyer,

storing in the processor standard maintenance, repair and operation parameters (which may be proprietary to the system or may be introduced into the processor by the buyer of these services),

requesting and receiving from the buyer specific buyer's data,

processing the specific buyer's data in the processor,

calculating buyer's requirements responsive to the specific buyer data input in view of the standard maintenance, repair and operation parameters, generating at the processor the buyer's request for proposal, and

transmitting the buyer's request for proposal to the buyer, and optionally to providers of maintenance, repair and operation services.

Another aspect of the subject matrix method is directed to a method of doing business in maintenance, repair and operation services industry which includes the steps of:

providing a processor accessible by a remote buyer of maintenance, repair and operation services over the Internet,

inputting into the processor specific buyer's data,

processing the specific buyer's data,

generating at the processor a request for proposal of maintenance, repair and operation services, and

transmitting the request for proposal from the processor to the buyer of maintenance, repair and operation services over the Internet or on-line connection for further use by the buyer of maintenance, repair and operation services in pursuit of the acquisition of maintenance, repair and operation services from the providers.

Optionally, upon approval of the request for proposal by the buyer, the processor transmits a generated document to a plurality of remote maintenance, repair and operation services providers, which respond with their proposals for the buyer consideration.

The whole process of maintenance, repair and operation services acquisition, including generating of the request for proposal, receiving of the proposal, and final negotiation between buyer and provider in accordance with the present invention is both time and cost efficient.

These and other novel features and advantages of this invention will be fully understood from the following detailed description of the accompanying Drawings.

### BRIEF DESCRIPTION OF THE DRAWINGS

FIG. 1 is a schematic diagram depicting a matrix technique of acquisition of maintenance, repair and operation services based on the computerized system of the present invention;

FIG. 2 is a block diagram depicting the maintenance, repair and operation services system of the present invention;

FIG. 3 shows a computer monitor screen presenting a main menu for interaction between a buyer and the computerized system of the present imvention;

FIG. 4 is a flow chart diagram describing the Customer Information portion of the unique software running the processor means of the present invention;

FIG. 5A depicts the Customer Information computer screen;

FIG. 5B depicts the Customer Information computer screen when a “Client Level” is selected;

FIG. 5C depicts the Customer Information computer screen when a “Building Level” is selected;

FIG. 6 depicts the Building Details computer screen;

FIG. 7 is a flow chart diagram, specifically detailing a Default Building Administration portion of the software running the processor of the present invention;

FIG. 8 is a flow chart diagram, specifically detailing a Pricing Matrix of the software running the processor of the present invention;

FIG. 9 depicts a computer screen showing a Specification Table;

FIG. 10 depicts a computer screen showing a plurality of Default Room Types;

FIG. 11 depicts a computer screen showing Default Floor Coverings;

FIG. 12 depicts a computer screen showing Default Quality Types;

FIG. 13 depicts a computer screen showing the List of Activities for each version of room/floor/rating;

FIG. 14 depicts a computer screen showing the Default Building Characteristics;

FIG. 15 depicts a computer screen showing the Default Building Types;

FIG. 16 depicts a computer screen showing the Default Industry Types;

FIG. 17 depicts a computer screen showing the Default Wages;

FIG. 18 depicts a computer screen showing the Pricing Matrix with routine and non-routine selection;

FIG. 19 depicts a computer screen showing the Scope of Work;

FIG. 20 depicts a computer screen showing the Routine Cleaning Data for Pricing Matrix;

FIG. 21 depicts a computer screen showing the Cost Summary;

FIG. 22 depicts a computer screen showing the Print Menu;

FIG. 23 depicts a typical Client Report printed on the printer;

FIG. 24 depict a typical Customer Report generated;

FIG. 25 depicts a typical Portfolio Report;

FIG. 26 depicts a typical specific Site Report;

FIGS. 27A-27C depicts a typical specific Building Specification Report;

FIGS. 28A & 28B depicts a typical specific Cost/Square Foot, Productivity, and Quality Report;

FIG. 29 depicts a typical specific Building Report;

FIG. 30 depicts a generated typical report showing Pricing Matrix for Specific Types of Work; and

FIG. 31 depicts a generated Cost Summary Report.

### DETAILED DESCRIPTION OF THE PREFERRED EMBODIMENT

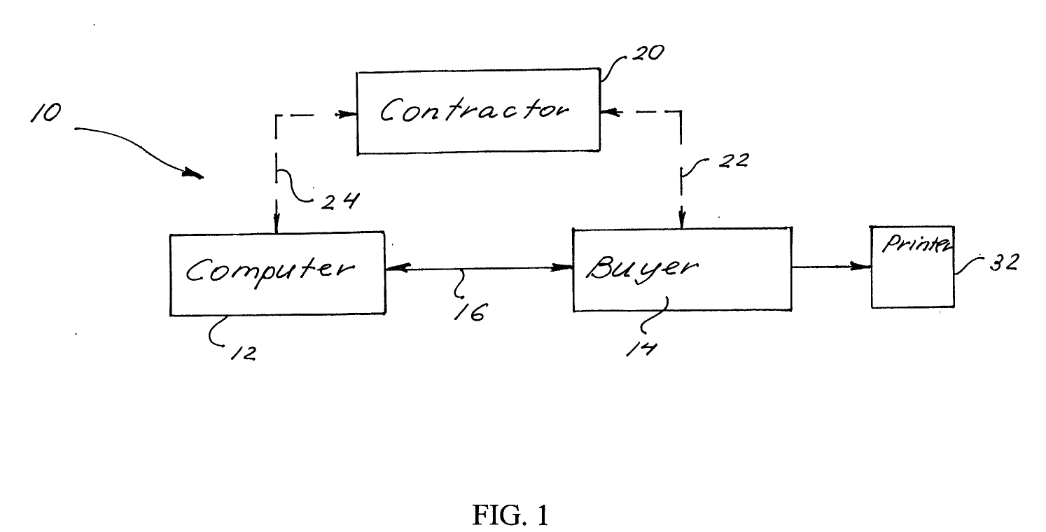

Referring to FIG. 1, system 10 of the present invention developed specifically for maintenance, repair and operation services acquisition processes includes computer or processor 12, which runs a software of the present invention installed in the processor 12 developed specifically for generating a request for proposal of maintenance, repair and operation services upon request of the buyer of the maintenance, repair and operation services based upon a matrix technique. The processor 12 is coupled to a remote buyer of maintenance, repair and operation services (specifically, to the buyer's computer) 14 over a communication channel 16 which may be the Internet. The communication channel 16 is a link between the processor 12 and the buyer's computer 14 allowing exchange of data therebetween in both directions. In this manner, the buyer may initiate communication with the processor 12 and may further input data requested from the buyer through the processor 12. The processor 12 transmits to the buyer's computer 14 a generated request for proposal (or any part thereof) upon the buyer's request.

Upon receiving the request for proposal at the buyer's computer 14, the buyer reviews the document, and upon approval, may use the request for proposal in a maintenance, repair and operation services acquisition process either by submitting the request for proposal to maintenance, repair and operation services providers personally or through the processor 12.

As shown in FIG. 1, for accomplishing maintenance, repair and operation services acquisition process, a plurality of providers, commonly defined herein as a contractor 20, may be accessed by the buyer through channel 22 (avoiding the processor 12) in order that the buyer may conduct the acquisition and negotiation process directly.

Alternatively, the contractor (defined by the contractor's computer) 20 is coupled to the processor 12 through the on-line channel 24 so that upon the buyer's request, the generated request for proposal is transmitted from the processor 12 to the contractor's computer 20. Upon receiving the request for proposal, the contractor 20 responds with his/her proposal, and the processor 12 processes the received information. The received information from the contractor 20, is further transmitted to the buyer's computer 14 for further consideration.

The system 10 for maintenance, repair and operation services acquisition permits a generation of a request for proposal in the matter of minutes; thus substantially decreasing the cost of maintenance, repair and operation services acquisition processes. The system 10 of the present invention also shortens the process of generating a bidding proposal from a maintenance, repair and operation services provider, thus even further simplifying the overall process and reducing cost and time consumption of otherwise rather lengthy, expensive, and complex services acquisition processes in the maintenance, repair and operation services industry.

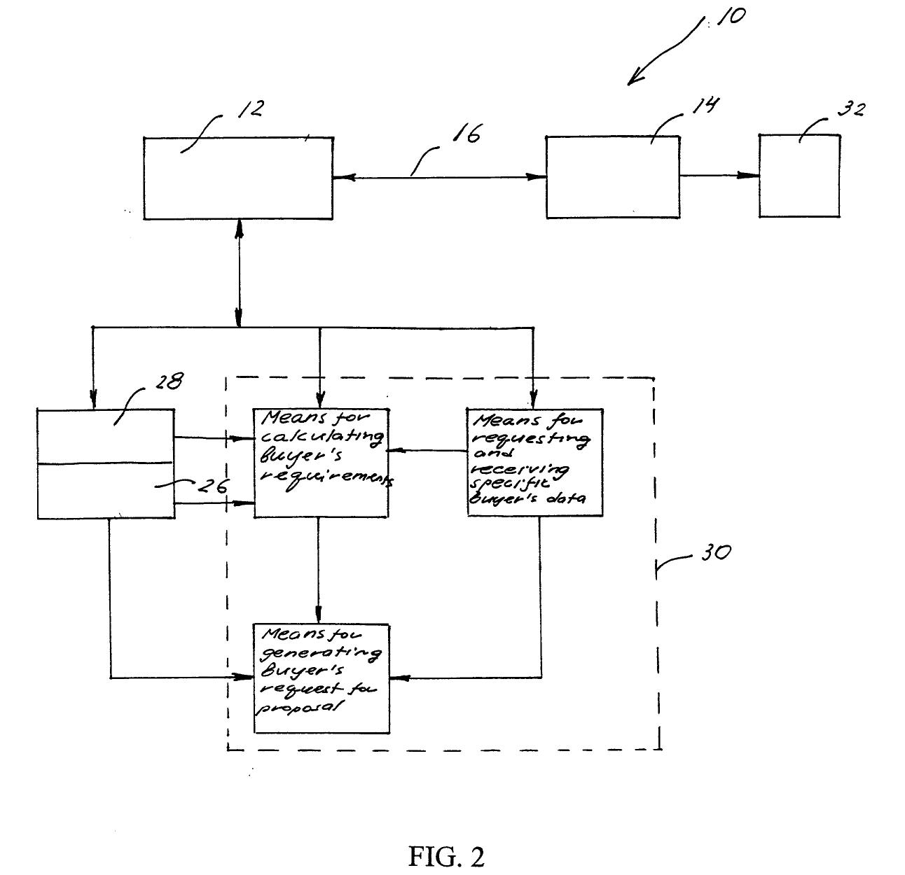

Referring now to FIG. 2 which shows in further detail the maintenance, repair and operation services matrix acquisition system and process of the present invention, the processor 12 includes a proprietary data base 26 of over 930,000 unique requests for proposal (further also referred to herein as RFP), a data base 28 with standard maintenance, repair and operation parameters, and software program 30 which requests and receives from the buyer specific buyer's data and further processes the same in accordance with an algorithm of the present invention, as will be described in further paragraphs.

The data base 28 of standard maintenance, repair and operation parameters includes statistical data related to the building for which the buyer seeks maintenance, repair and operation services, such as local labor rates, costs for uniforms, costs for equipment, costs for supplies, paper costs, overhead expenses, profit mark-ups, etc. The specific buyer data requested by the software 30 additionally includes name of the buyer, address of the building, building details, the industry within which the building is affiliated, square footage of the building, square footage of the area to be cleaned, breakdown for each type of space in the building (for example, conference room vs. offices vs. rest rooms vs. hallways, etc.), type of floor covering, level of cleaning, frequency of the cleaning, etc.

Specific buyer data requested from the buyer by the processor 12 further includes labor rates related specifically to the building for which the maintenance, repair and operation services are to be acquired. The specific buyer information is entered into the processor 12 by the buyer, while the standard maintenance, repair and operation parameters are either supplied from the data base 28 or are requested from the buyer. Other parameters used in the process of calculating and generating the request for proposal, includes information on whether the building is union or non-union labor, since this information may also affect the output of the buyer's request for proposal.

The program 30 in the processor 12 calculates the buyer's requirements responsive to the specific buyer data input in view of the standard maintenance, repair and operation parameters from the data base 28 and generates a particular request for proposal. The generated request for proposal is transmitted to the buyer's computer 14 through the communications channel 16. At the buyer's end, the request for proposal (the whole RFP document, or any part thereof) may be printed out through printer 32.

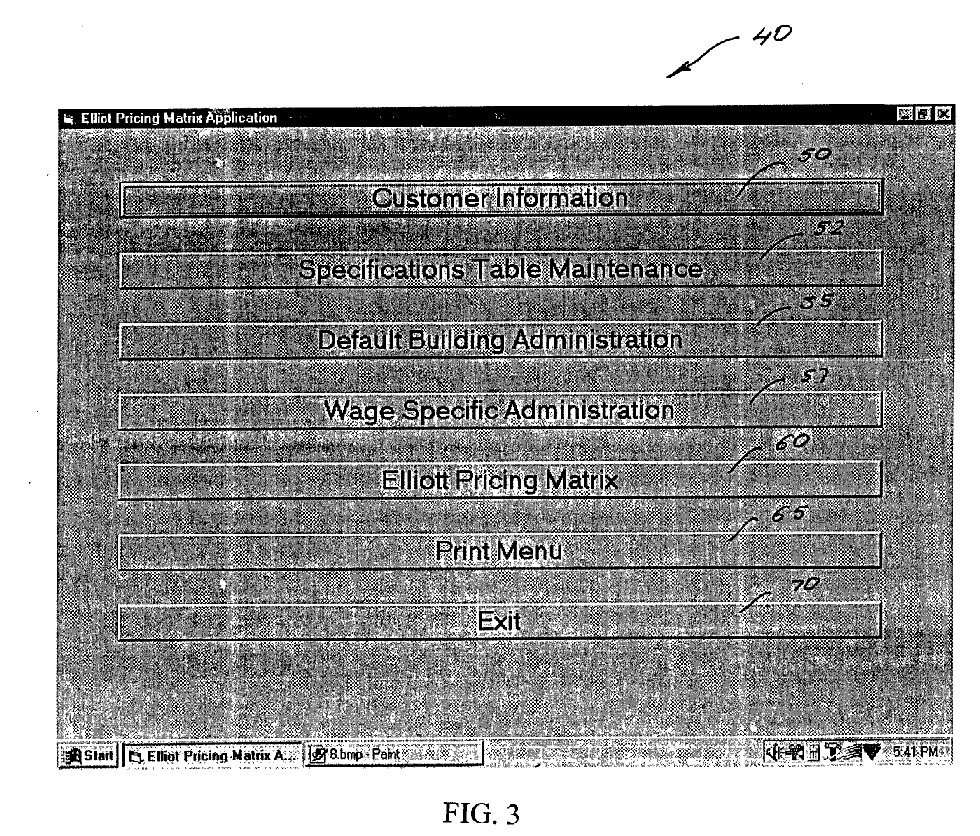

Turning to FIGS. 3-22 which show the flow chart diagram of the software of the present invention for maintenance, repair and operation services acquisition relating to computer screens presented as the display on the buyer's computer as a means for interaction between the buyer and the software. The buyer accesses a specific predetermined web site. A screen showing a main menu 40 presented in FIG. 3 appears on the display of the buyer's computer 14. The main menu 40 includes box 50 “Customer Information”, box 52 “Specifications Table Maintenance”, box 55 “Default Building Administration”, box 57 “Wage Specific Administration”, box 60 “Pricing Matrix”, box 65 “Print Menu”, and box 70 “Exit”, all of which may be activated.

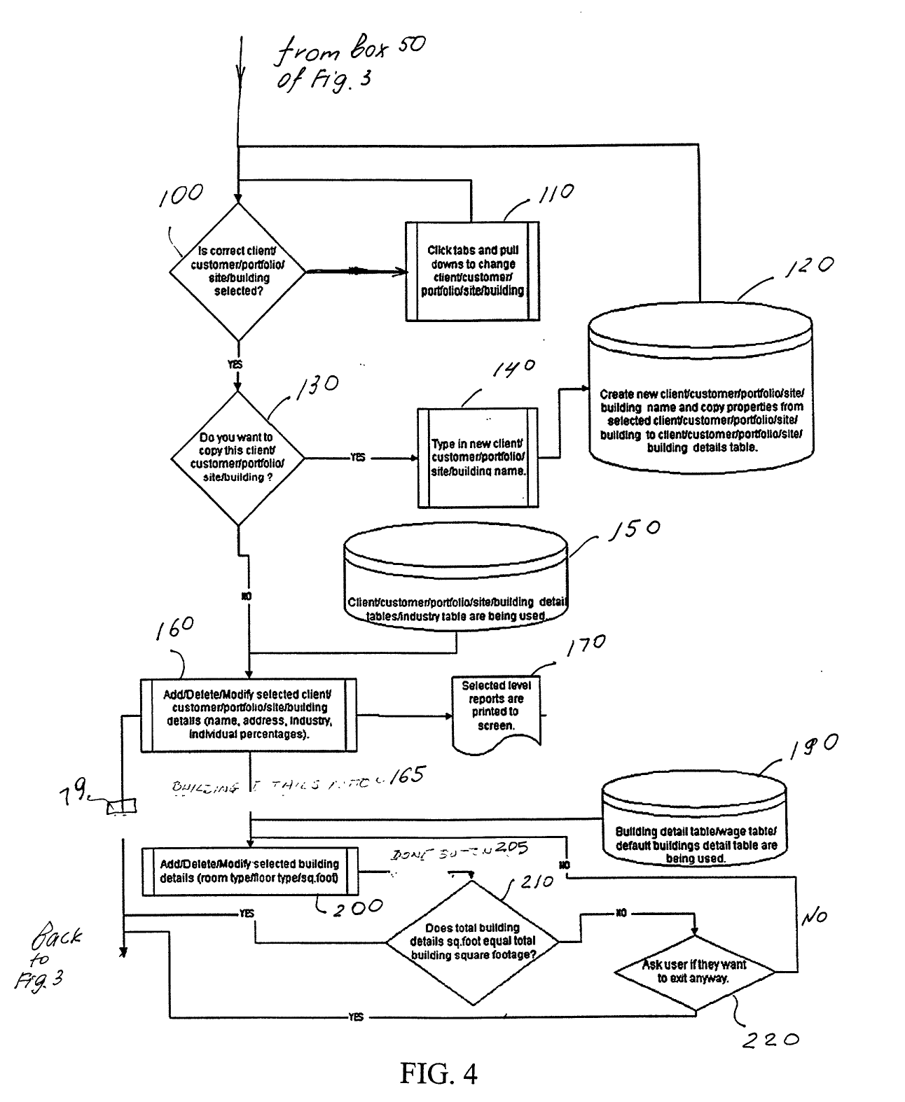

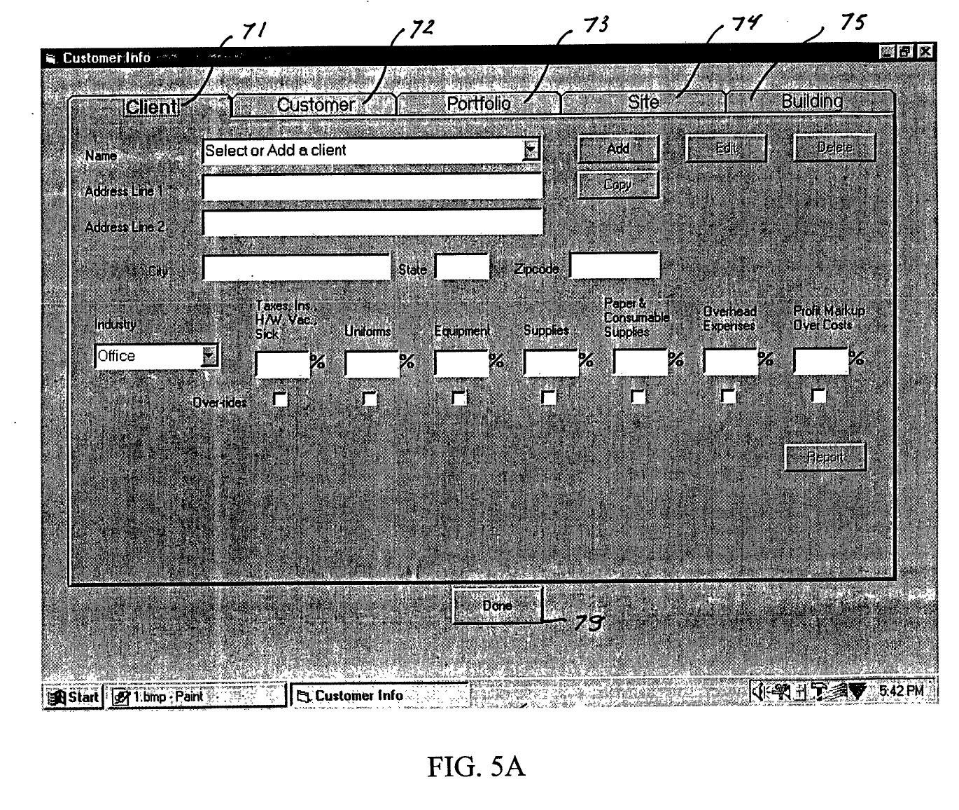

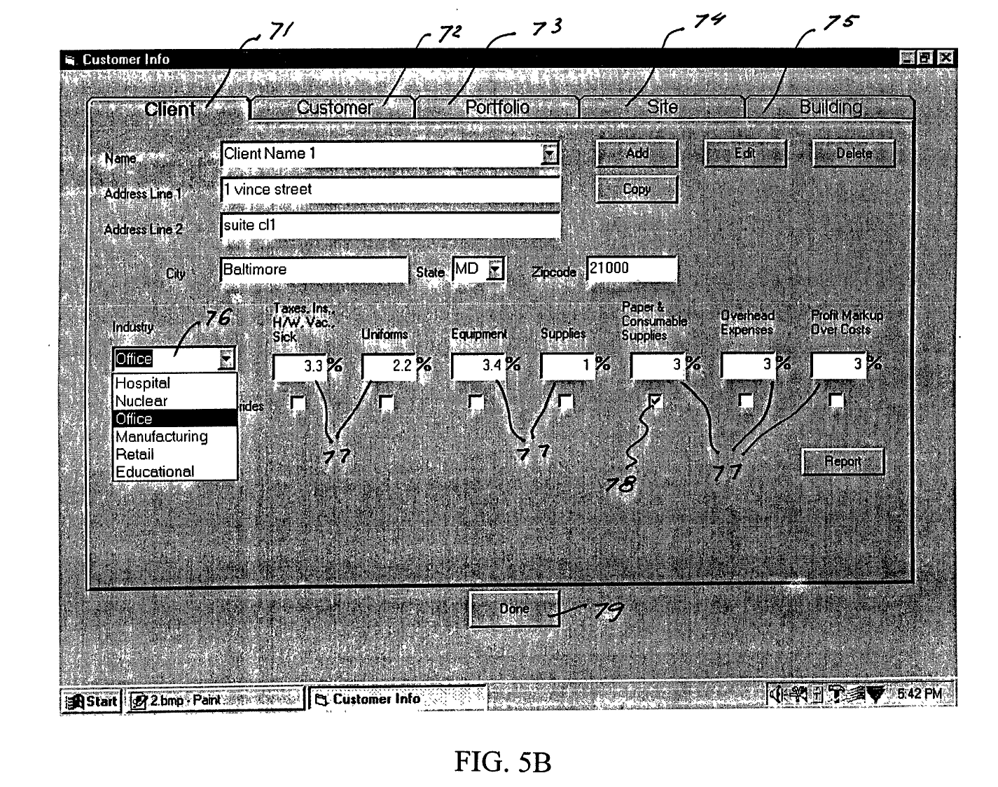

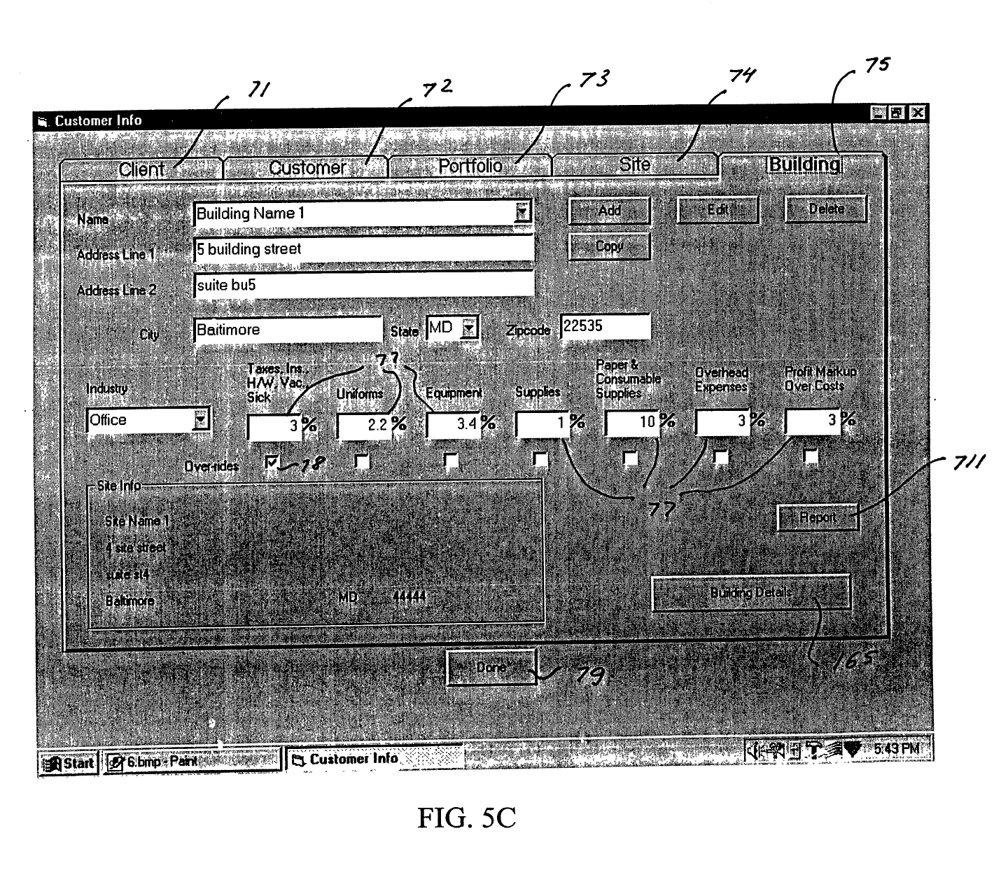

The process of generating of a request for proposal starts with the buyer pointing the screen box 50 “Customer Information” after which the software 30 switches to the procedure flow chart which is shown in FIG. 4. This is initiated with the logic block 100 “Is Correct Client/Customer/Portfolio/Site/ Building Selected?” In this instance, a screen shown in FIG. 5A appears on the display of the buyer's computer, and the buyer is presented with five levels of information available in the proprietary data base 26 from which the buyer chooses the information needed for further processing or which may be changed by the buyer as will be described in further paragraphs.

As can be seen in FIG. 5A, “Client/Customer/ Portfolio/Site/Building” tabs 71-75 are presented on the horizontal bar at the top of the computer screen. However, other presentation arrangements are envisaged within the scope of the present invention. As herein described, the “client” means the name of a buyer purchasing the maintenance, repair and operation services, the “customer” means, for example, a branch of the “client” for which the maintenance, repair and operation services are to be acquired, the “portfolio” means related client properties; the “site” means the locations at which the maintenance, repair and operation services are needed, and the “building” means a specific building where the services such as cleaning is to be performed.

Referring again to FIG. 4, from the block 100, the logic flows to the block 110 “Click Tabs and Pull Downs to Change Client/Customer/ Portfolio/Site/ Building”, instructing the buyer for further actions required to edit the request for proposal presented to the buyer on the screen of computer 14. Once the buyer “clicks” or chooses one of the tabs 71-75, responsive information appears on the screen within the windows shown in FIG. 5A. This information can be selectively changed by adding, copying, deleting, or editing the existing information when the buyer actuates respective buttons on the screen of FIG. 5A.

As an example, when the buyer desires to work with the “client” level of information, the buyer clicks or otherwise actuates the tab 71 and the information relative to the “client” appears on the screen as shown in FIG. 5B. The buyer can pull down a list of existing clients' names in the window “Name”, and select the one he or she is going to work with. Referring to FIG. 4, the logic simultaneously returns from block 110 to block 100 and the buyer may pull down and actuate different tabs on the screen of FIG. 5B in order to select a piece of data that the buyer wishes to enter.

As soon as the correct Client/Customer/Portfolio/Site/ Building is selected, i.e., the answer to the question in the block 100 of FIG. 4 is “Yes”, the flow chart proceeds to the logic block 130 “Do You Want to Copy This Client/Customer/ Portfolio/Site/Building?” If the answer is “Yes”, (corresponding to the situation when the buyer clicks or actuates “Copy” of FIG. 5B), the flow chart proceeds to the block 140 “Type in New Client/Customer/Portfolio/Site/Building Name” (the buyer actuates “Add” on the screen of FIG. 5B and types in a new client name). A new name is further recorded in the information carrier, for example hard disk, 120 and into the proprietary data base 26 where new client/customer/portfolio/ site/building names and new details are stored. From the data base 120, the information may be supplied again to the block 100 upon the user's request.

Alternatively, if the answer to the logical block 130 is “No”, the logic flows to the block 160 “Add/Delete/ Modify Selected Client/Customer/ Portfolio/Site/Building Details (name, address, industry, individual percentages)”. In this block, the information such as specific buyer's data is requested from the buyer and upon the file being edited in block 160, the information is stored in the data base 150. If the buyer is satisfied with the edited file in 160, he/she may request (by actuating “Report” of this screen of FIG. 5B) to print selected level reports to the screen in block 170, out of which the selected reports may be requested to be printed at the printer 32.

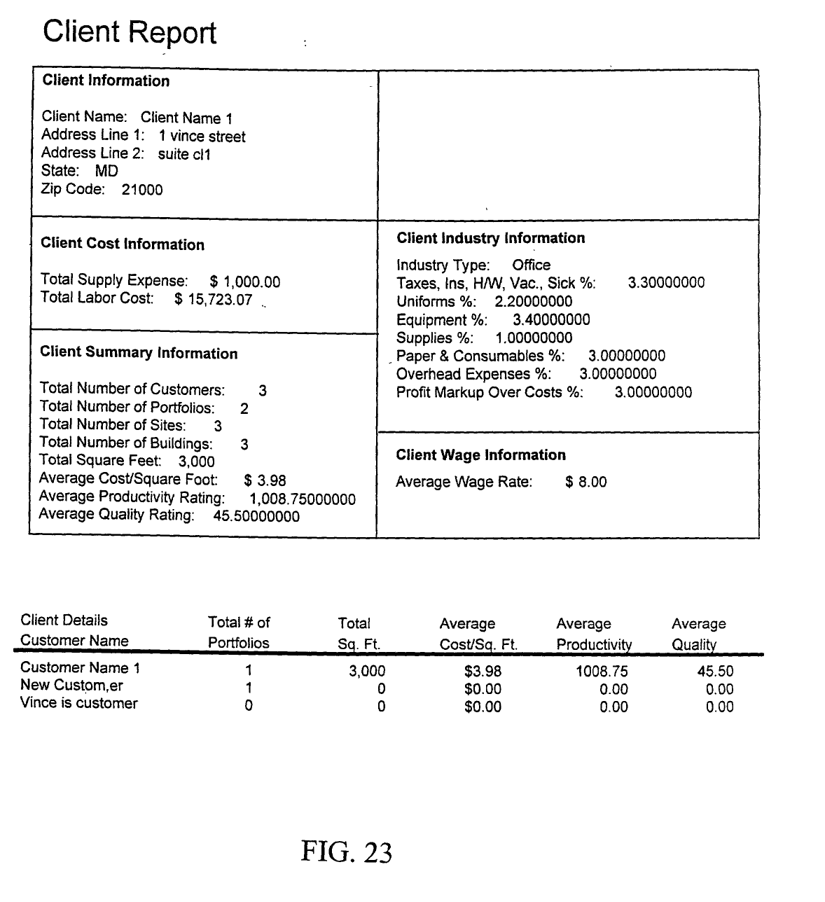

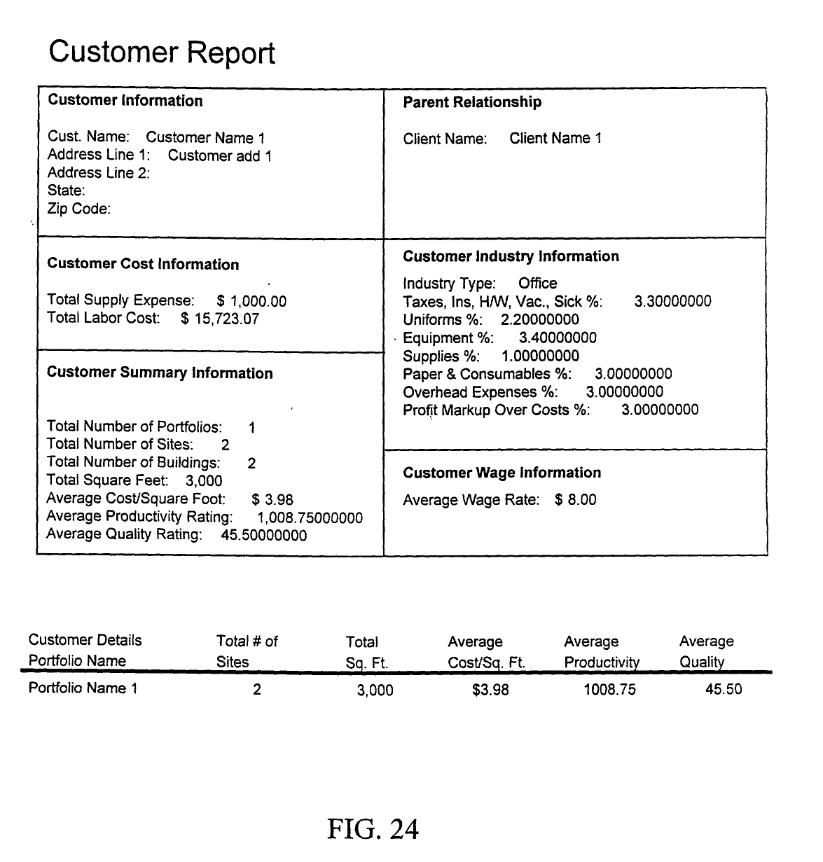

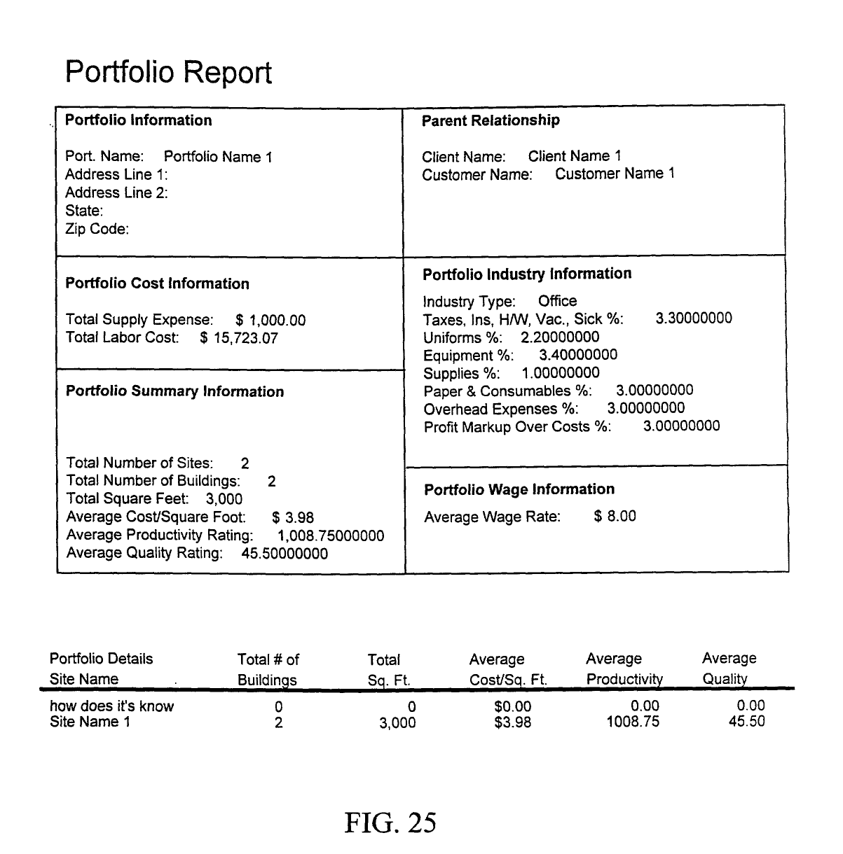

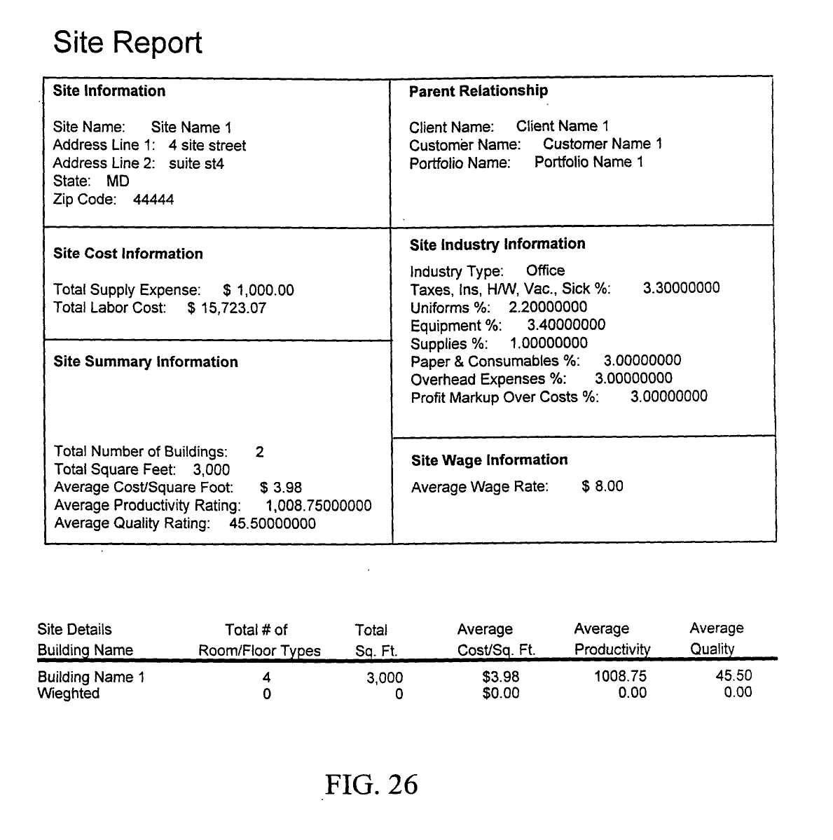

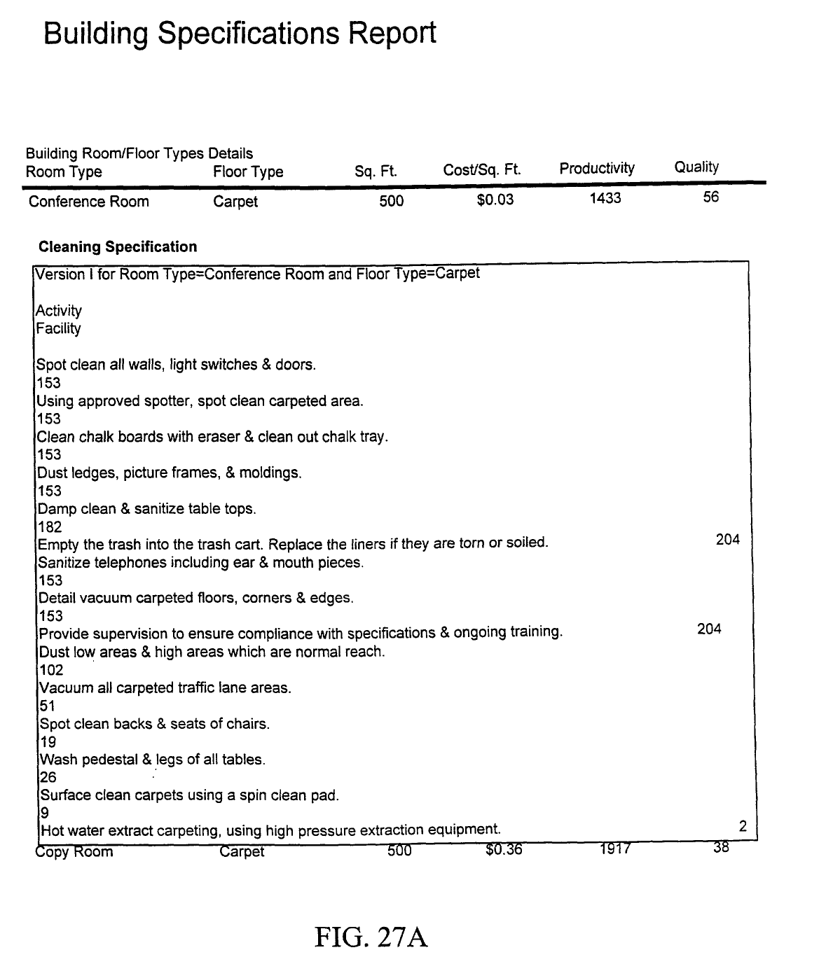

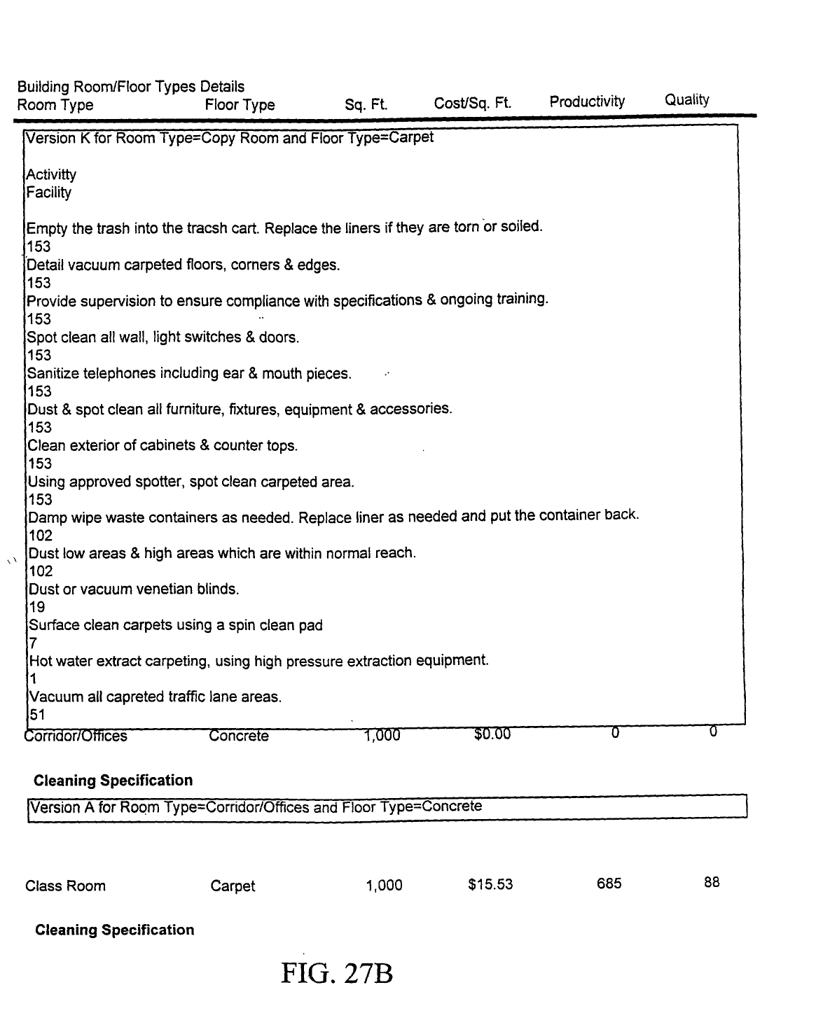

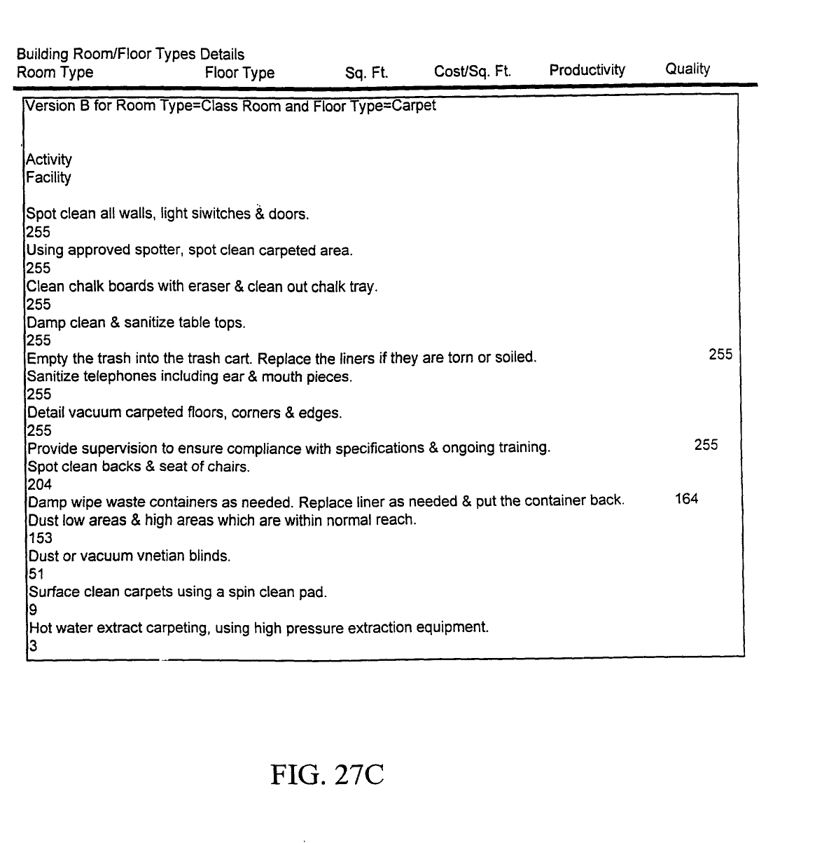

Depending upon which level of information the buyer is working with, different types of reports may be printed upon actuating “Report” of FIG. 5B. For example, if it is “Client” level (tab 71), a typical client report shown in FIG. 23 will be printed out. However, if it is “Customer” level (tab 72), the Customer report shown in FIG. 24 will be printed. Alternatively, if it is “Portfolio” level (tab 73), then the Portfolio Report, shown in FIG. 25 will be printed. If it is “Site” level of information (tab 74), then the Site Report shown in FIG. 26 is printed by printer 32. And finally, for the “Building” level (tab 75), a Build Report shown in FIGS. 27A-C is printed out.

The system of the present invention permits consideration of an overall price quote of the request for proposal based upon the parameters of the specific industry of the building to be cleaned. This is done by providing the buyer with a list of industries in a window 76 from which he/she can select a related industry. Upon the selection of the type of the industry, the windows 77 are automatically filled with the information which is standard to the selected industry and which identifies what portion (%) of the overall quote of the request for proposal is allotted for such expenses as taxes, insurance, hours per week, vacations, sick days, uniforms, equipment, supplies, paper and consumable supplies, overhead expenses, and profit mark-ups over costs.

This information is maintained in the proprietary database 26 and is provided to the buyer. However, there is provided an opportunity for the buyer to override the information and to fill in the information by him/herself. This is accomplished by checking a respective “Overrides” window for example, the window 78 of FIG. 5B and by filling the information into a respective one of the windows 77.

When details on the selected information level (client, customer, portfolio, site or building) are added, modified, or deleted (corresponding to the block 160 of the flowchart shown in FIG. 4), the “Done” button 79 is clicked, and the logic returns from the block 160 to the screen of FIG. 3.

While working on the Building level of information (tab 78), a screen shown in FIG. 5C appears on the display. This screen presents to the buyer a button “Building Details”, which corresponds to the “Building Details” button 165 shown in FIG. 4.

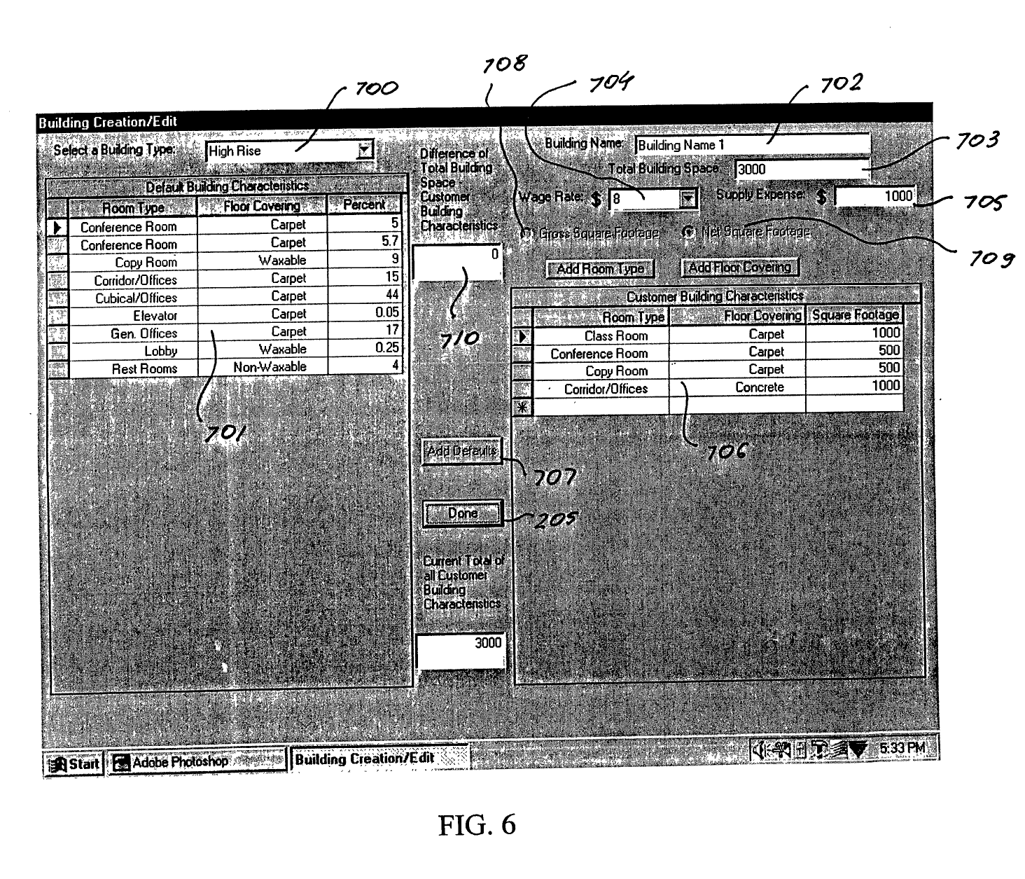

Upon “Building Details” 165 being actuated by the buyer, the logic flows to the box 200 (of FIG. 4) “Add/Delete/Modify Selected Building Details (room type/floor type/square foot)”. In this instance, information is displayed on the screen of the computer 14 from the data base 190 “Building Detail Table/Wage Table/Default Detail Table” in the form of the screen shown in FIG. 6. The buyer is requested to provide further information with regard to the building details by editing data from the data base 190 shown at the screen of FIG. 6.

Specifically, in the window 700, the buyer may select a type of the building in question by pulling it from the table 701 “Default Building Characteristics”. In the window 702, the building in question name is displayed. The windows 703, 704 and 705 display the user editable information related to the total building space, wage rate in the building and, supply expense, respectively.

The buyer may select customer building characteristics from the icon 706. The button 707 “Add Defaults” applies %'s to total building space and loads the list in the customer building characteristics only when the icon 706 is blank.

The buttons 708 “Gross Square Footage” and 709 “Net Square Footage” are to be “checked” before customer building characteristics are loaded. If, for example, the button 709 is “checked”, and the button 707 “Add Default” is actuated, the software will allocate 15% to uncleanable space. When the entered building information is processed, and the “done” button 205 is actuated, the logic flows to the block 210 of FIG. 4 in which a difference is calculated between total building square footage and building details square footage. The results of the calculation in the block 210 are displayed in the icon 710 on the screen of FIG. 6, which is then replaced on the display with the screen shown in FIG. 5C.

Upon actuating the “Report” button 711 of FIG. 5C, the reports illustrated in FIGS. 27, 28A, 28B and 29 are printed by the printer 32.

Referring again to FIG. 4, if the answer in the block 210 is “No”, the logic proceeds to the block 220 “Ask User if They Want to Edit Anyway”. If the answer to the block 210 is “Yes”, the logic returns to the screen shown in FIG. 3. If the answer to the block 220 is “No”, the logic flows to the block 200 for further editing of the building details. If, however, the answer to the block 220 is “Yes”, the flow returns to the screen of FIG. 3, i.e., to the main menu 40. Thus, the flow chart shown in FIG. 4 permits the software of the present invention to request and receive from the buyer information on client/customer/portfolio/ site/ building properties such as name, address, industry, individual percentages, building details, room type, floor type, square footage of building and space to clean, as well as other standard parameters.

When the customer information entrance and processing in box 50 of the main menu 40 of FIG. 3 is completed, the software flows to the “Specification Table Maintenance” (box 52) which is an information database on room/floor type.

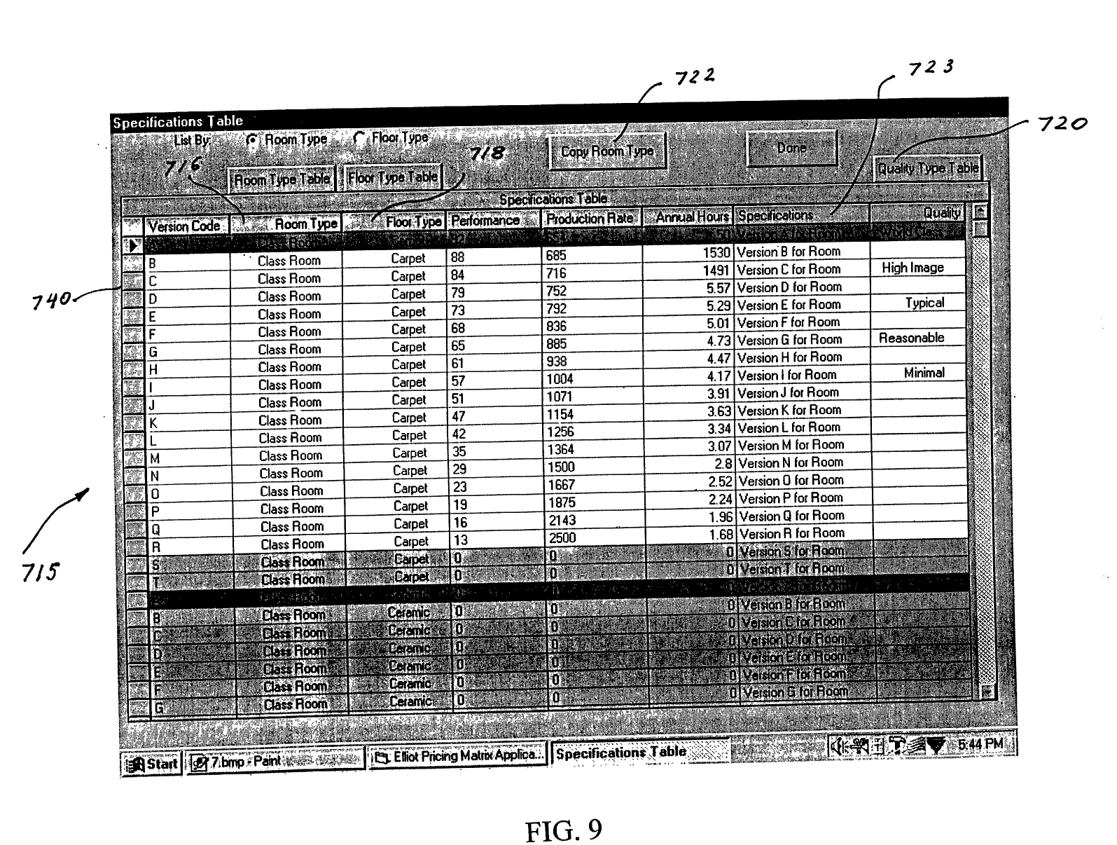

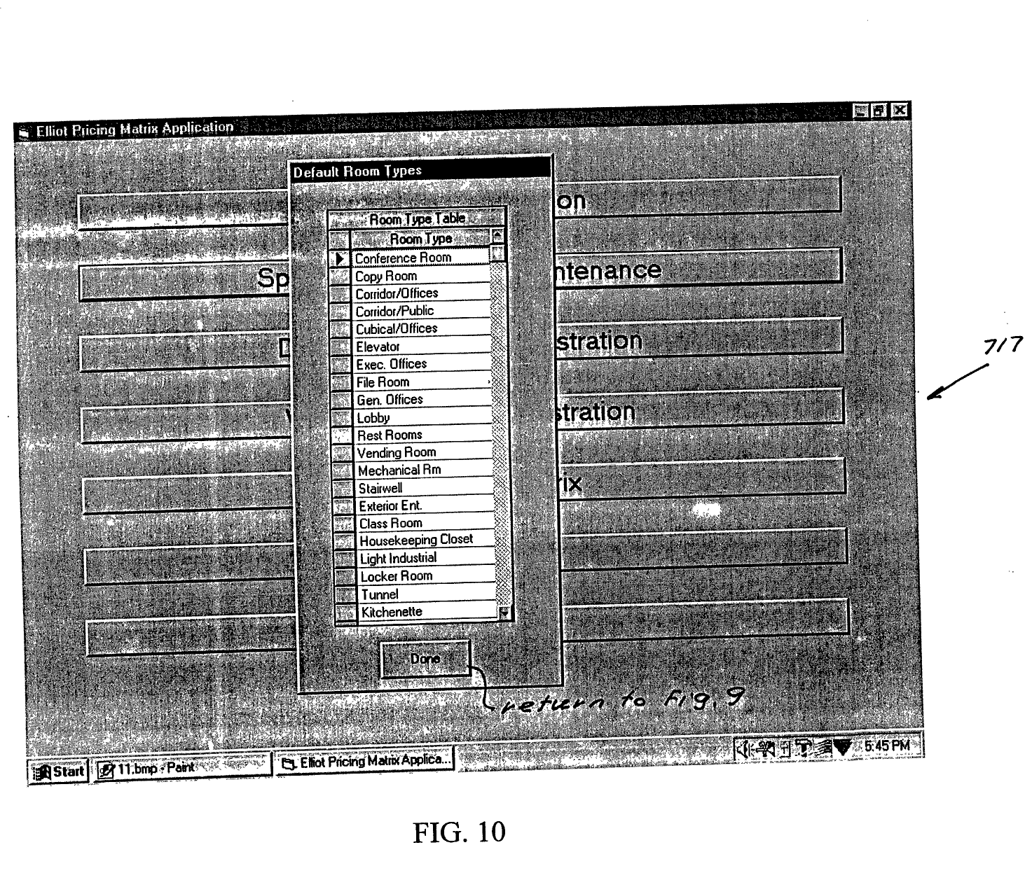

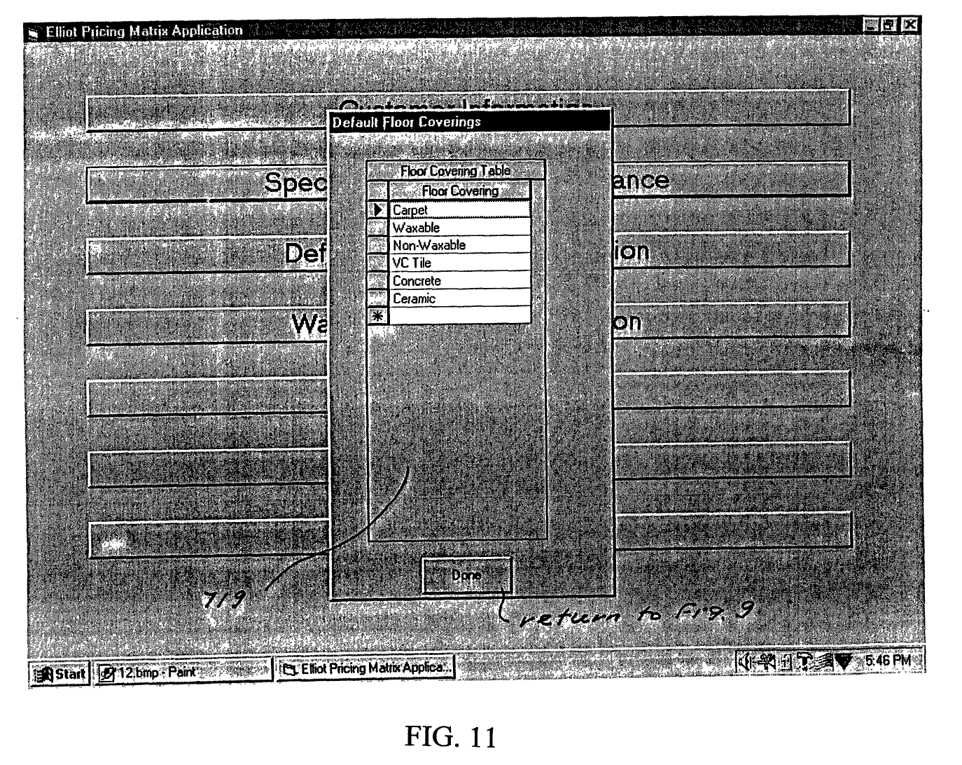

Specifications table 715 is shown in FIG. 9 and is presented at the screen of the buyer's computer upon actuating box 52 of FIG. 3. Table 715 is input by the buyer with the information pulled from other screens. For example, the “Room Type Table” 716 of FIG. 9 is input with information selected by the buyer from the screen 717 showing the list of possible room types presented in FIG. 10. The floor type table 718 is filled when the buyer selects a respective floor type from the table 719 shown in FIG. 11.

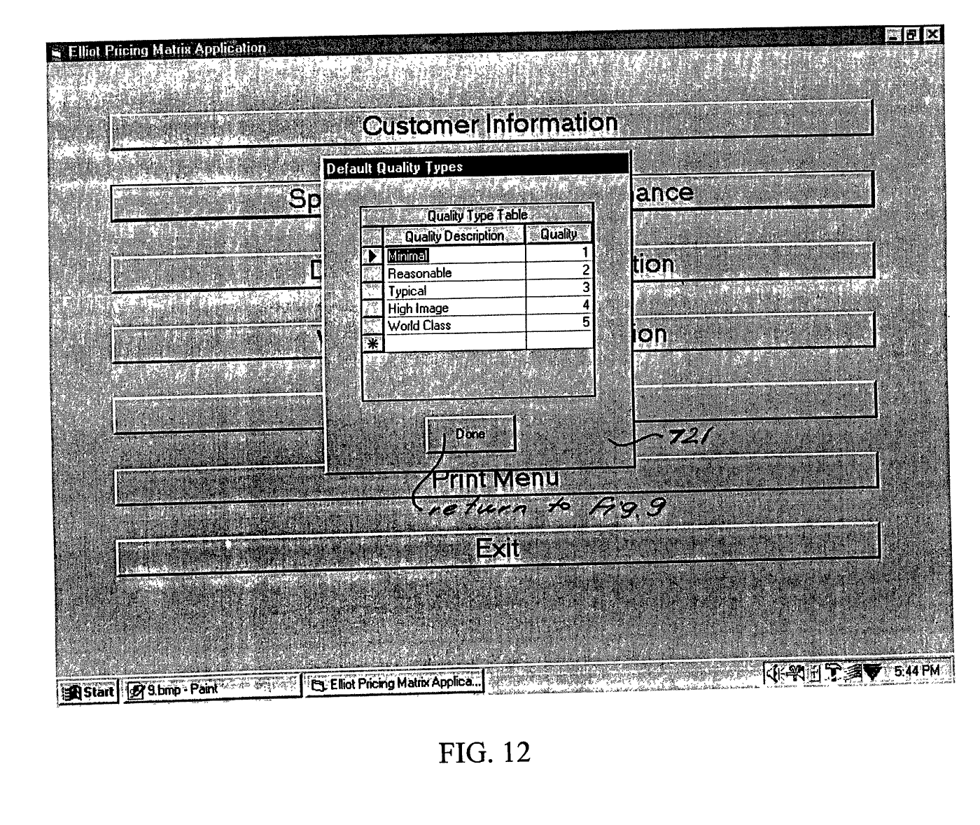

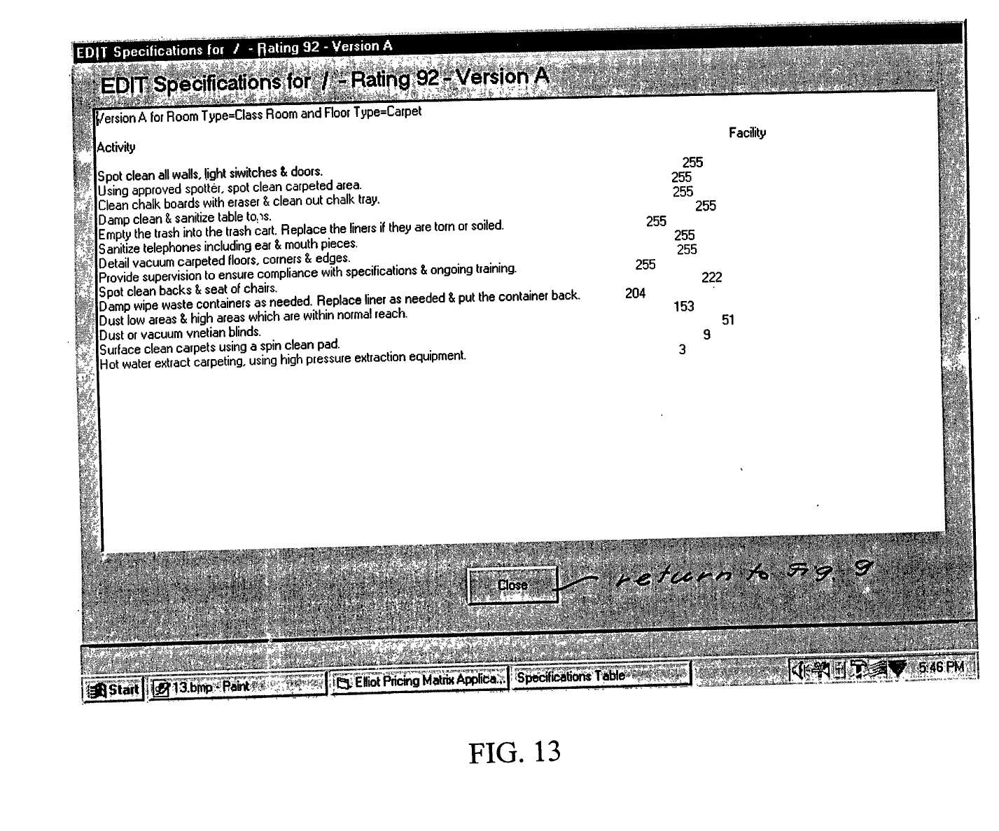

The quality type table 720 of the Table 715 is filled by information from table 721 shown in FIG. 12. The buyer may select performance parameter in order that the software will calculate corresponding production rate and annual hours needed to accomplish such a performance in view of all other input data. Actuating any cell in the column 723 of the table 715 will result in printing on the screen of a specification shown in FIG. 13 which presents a list of activities for each version of a room/floor/rating from which the buyer selects the data needed.

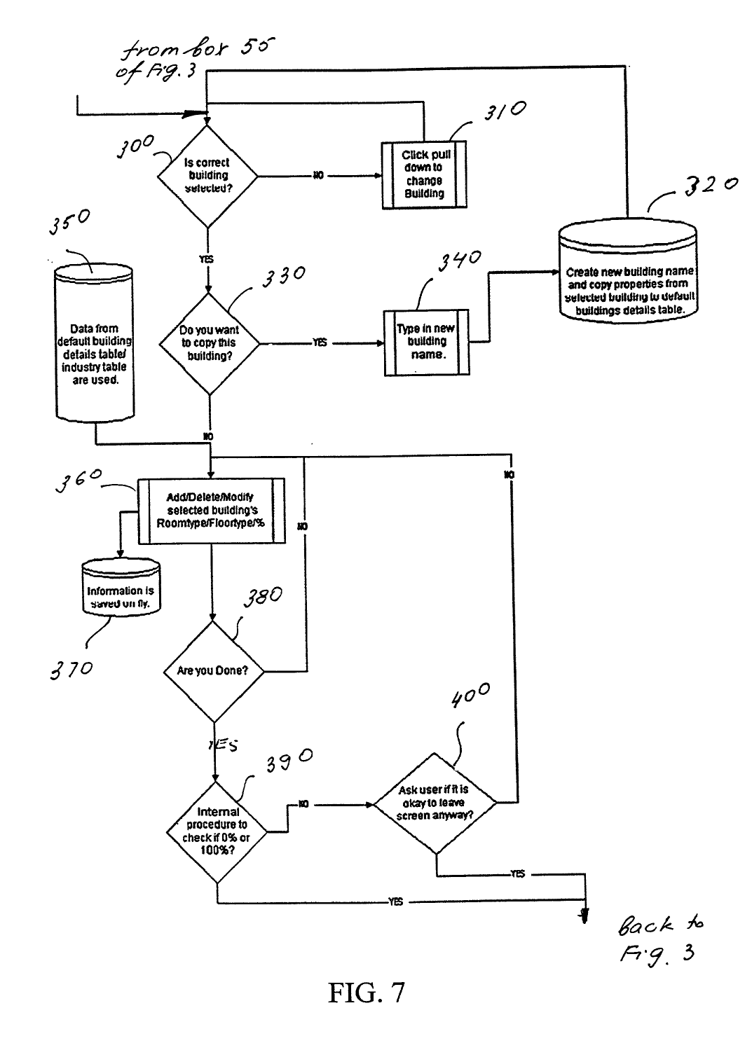

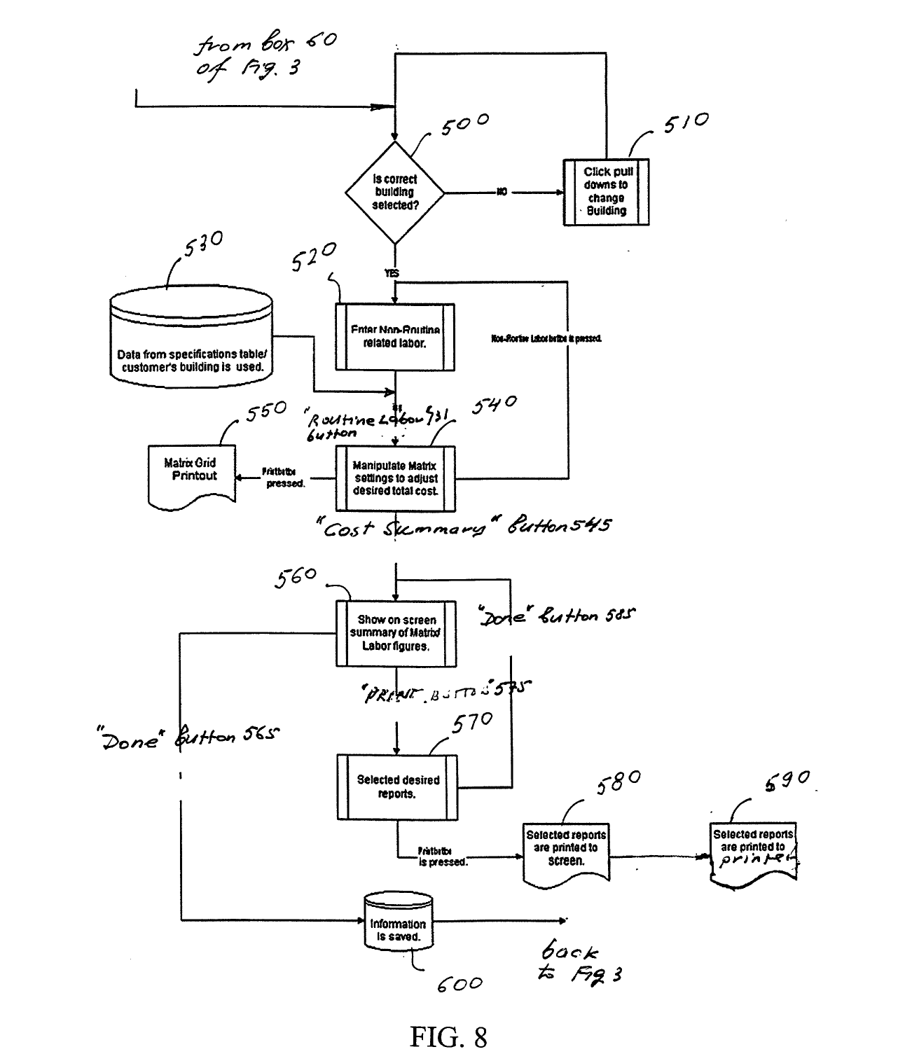

When the “Customer Information” (box 50) and the “Specifications Table Maintenance” (box 52) of the main menu 40 of FIG. 3 is completed, the buyer moves to the block 55 “Default Building Administration” of the main menu 40 from where the logic flows to the flow chart shown in FIG. 7, which is initiated with the logic block 300 “Is Correct Building Selected?”. The buyer may select a building from a plurality of buildings from proprietary data base 320 (a portion of the data base 26).

If the building appearing on the screen of the computer 14 is incorrect, the buyer actuates the button in the box 310 “Click Pull Down to Change Building” in order that next building from the proprietary data base 320 appears on the screen of the computer 14.

The process continues until the correct building is selected, and then the logic flows from the box 300 to box 330 “Do You Want to Copy This Building?”. If the buyer wants to copy this building, the logic flows to the block 340 “Type in New Building Name”. When the buyer gives a new name to the building, it is copied to the data base 320 in which a new building name and properties from the selected building are copied for further use in block 300.

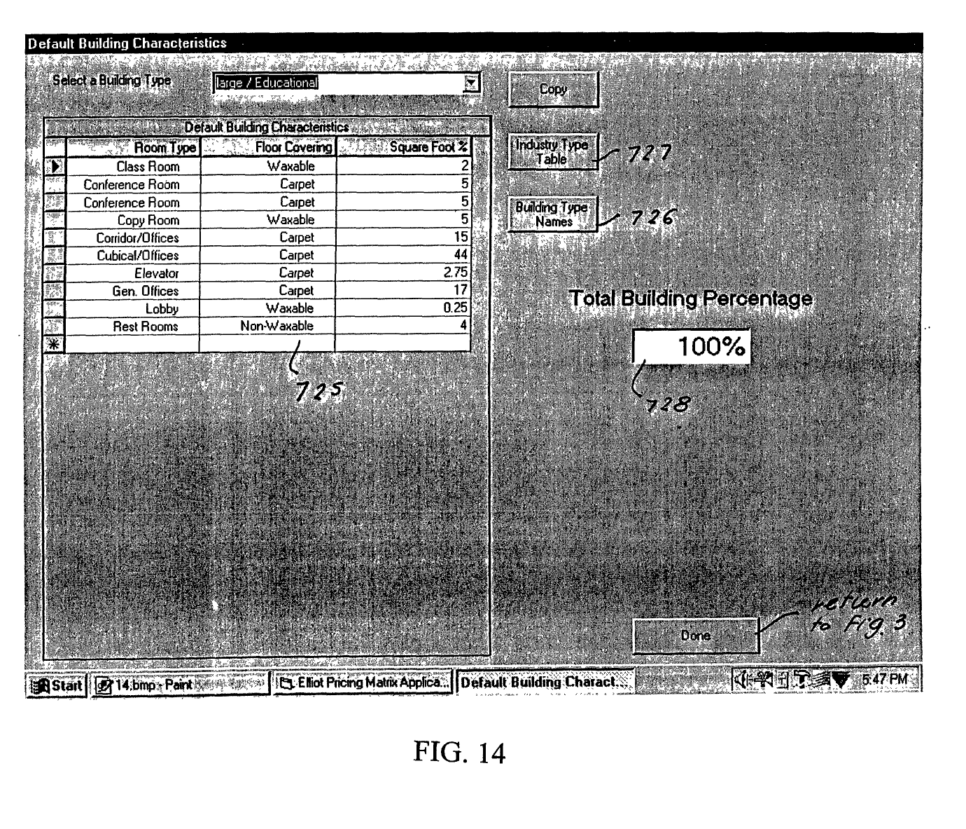

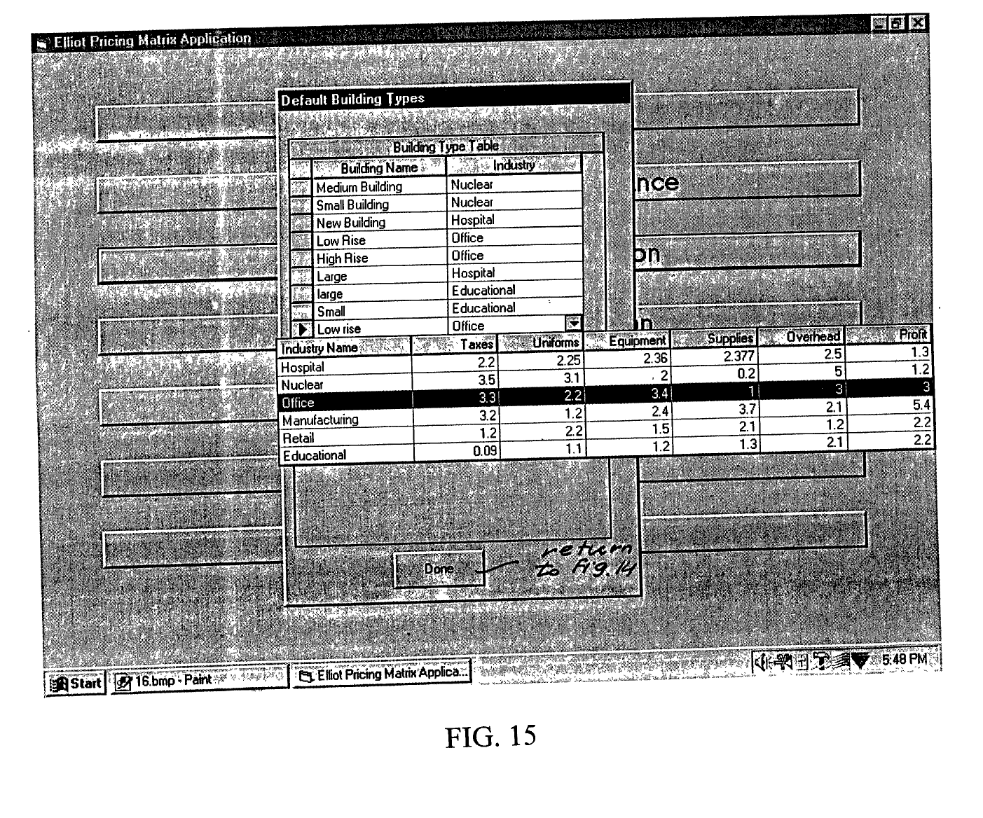

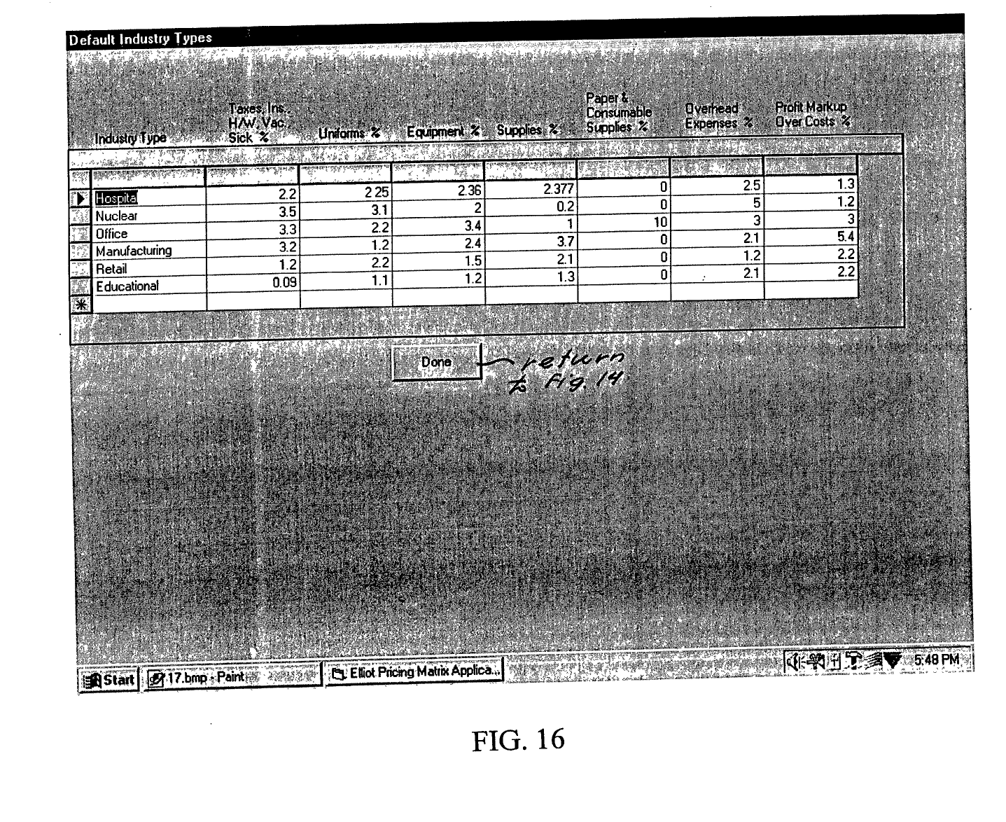

If the building is not to be copied, the logic flows to block 360 “Add/Delete/Modify Selected Buildings Room Type/Floor Type/%”. In the same instance, information from the data base 350 which represent “Data from Default Building Details/Table/ Industry Table” is presented to the buyer by pulling up the screen shown in FIG. 14, where the information presented in the icon 725 is user editable. By actuating button 726, a table shown in FIG. 15 appears on the screen, and when the button 727 is actuated, the table shown in FIG. 16 is presented to the buyer so that he/she can select a needed information to be entered into the system.

Upon editing the selected building's properties, the information from the block 360 is saved in data base 370. When the editing process in the block 360 is finished, the buyer is requested in the block 380, “Are You Done?”. If the answer is “No”, the logic flows from the block 380 to the block 360 for further editing of the information related to the building's properties. If the answer is “Yes”, the logic flows from the block 380 to the block 390 “Internal Procedure to Check if 0% or 100%?”. The result is shown in the icon 728 of the screen shown in the FIG. 14.

The Building percentage of an area to be cleaned to the whole area of the building is calculated using data from the table 725. If the answer is “Yes”, the logic returns from block 390 to the main menu 40 in FIG. 3. If the answer is “No” however, the logic flows from the block 390 to block 400 “Ask User if it is Okay to Leave Screen Anyway?”. If “Yes”, the logic flows to the main menu 40 shown in FIG. 3. If “No”, the logic flows from the block 400 to the block 360 for further editing procedures related to building's properties.

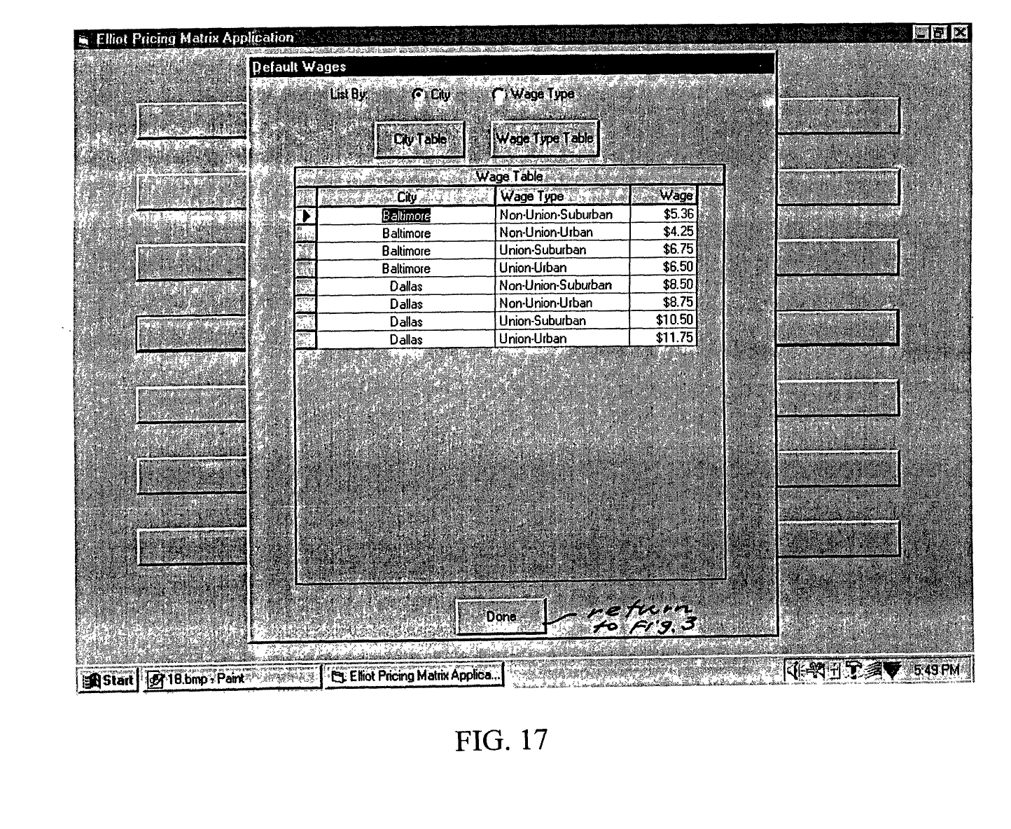

After the “Default Building Administration” portion of the main menu 40 is contemplated, the logic moves to the “Wage Specific Administration” box 57 of the main menu 40 in FIG. 3. In this instance non-editable information on wage specifics relative to geographical location of the building, as well as wage type (union, non-union, suburban, or urban) is presented to the buyer on the screen, as shown in FIG. 17 where the buyer can select a city and wage type from the table.

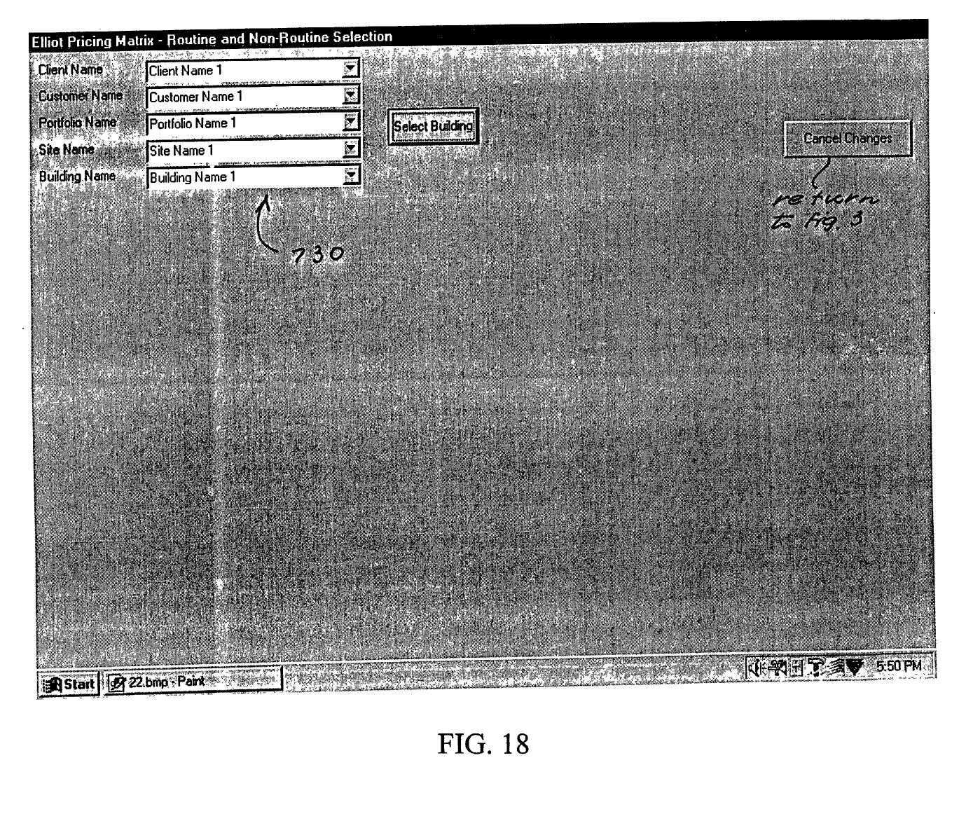

After the “Wage Specific Administration” box 57 of the main menu 40 in to FIG. 3 is completed, the logic moves to the block 60 “Pricing Matrix”, where the flow chart switches to the software branch shown in FIG. 8. The flow chart shown in FIG. 8 requests data from the buyer which is unique to the building to be serviced. For this, the software displays a screen shown in FIG. 18 which has a series of pull-downs 730 which the buyer uses to select a desired building. If the building selected is not the one which is intended by the buyer, the buyer is offered the option to change the building in the block 510 and the process is repeated until the correct building is selected.

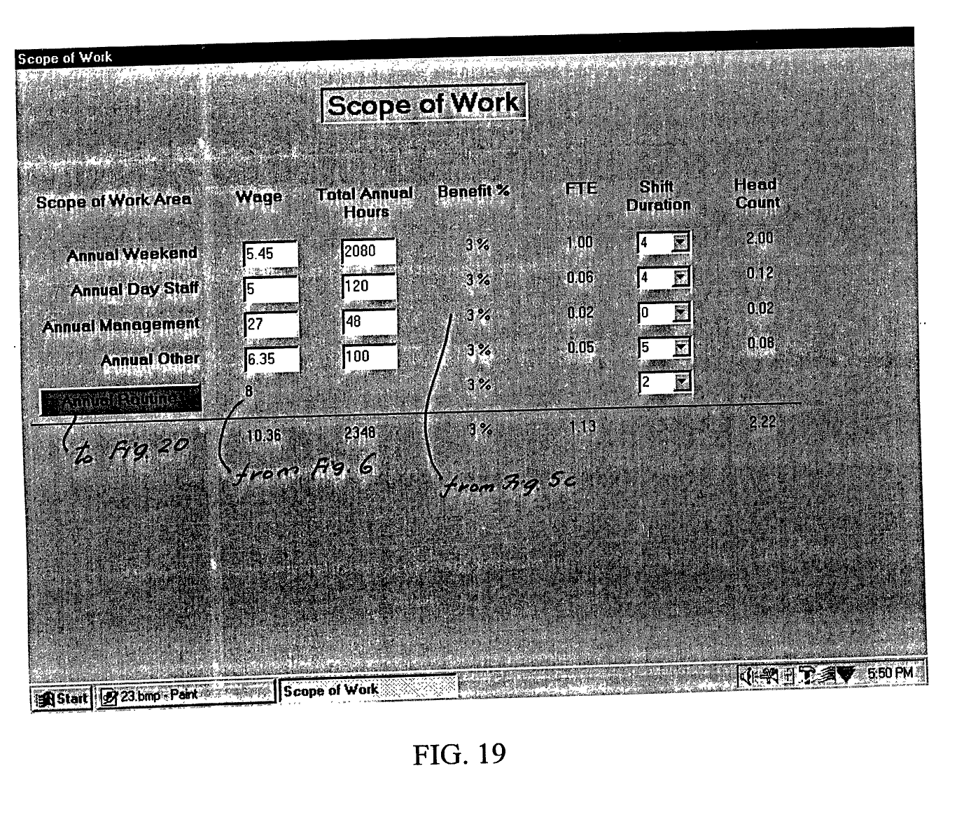

In this instance, once the correct building is selected, the logic flows from block 500 to 520 “Enter Non-Routine Related Labor”, i.e., the buyer is requested to enter information on annual weekend wage and total hours the buyer is willing to pay to a contractor. This information is presented to the buyer as a screen shown in FIG. 19 where the wage, total annual hours and shift duration is user editable information, the benefits are entered automatically from the icon 77 (Taxes, Ins, H/W, Vac, Sick) of FIG. 5C, and FTE and Head Count are calculated as will be disclosed in following paragraphs.

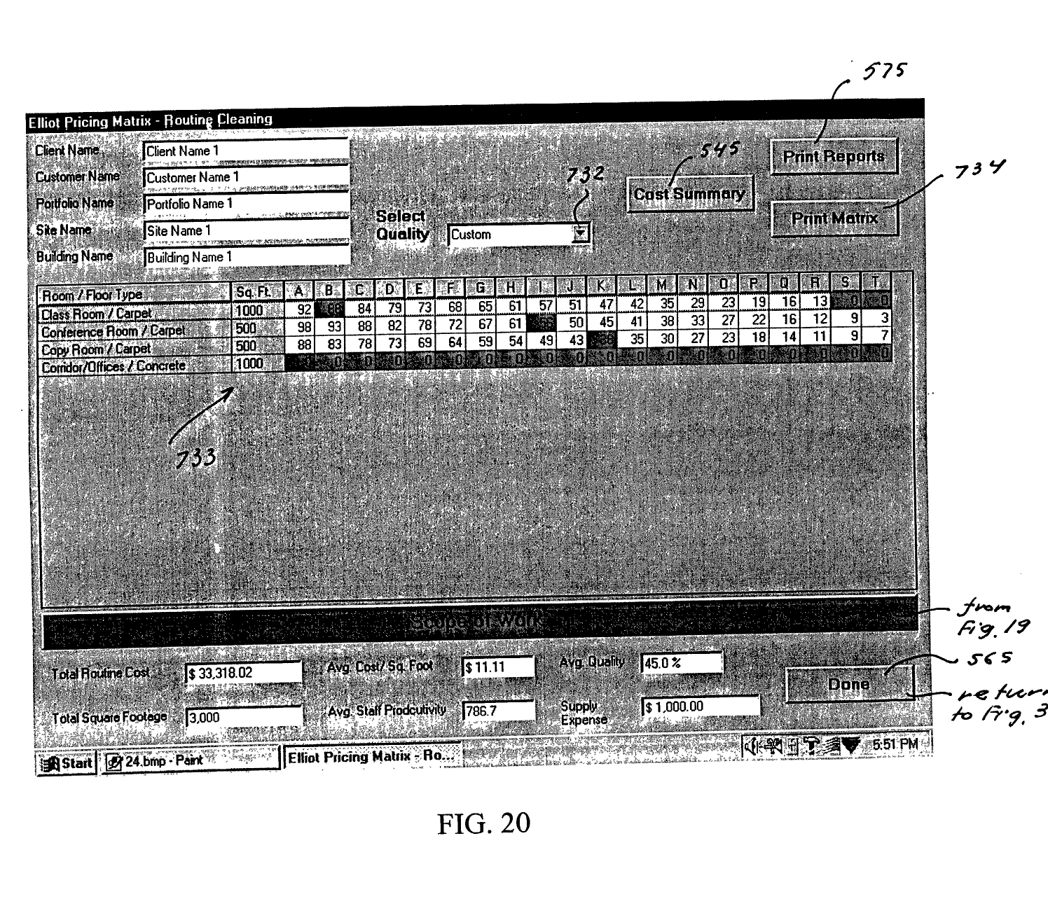

Subsequent to the information being entered, the logic flows from the block 520 to 540 “Manipulate Matrix Settings to Adjust Desired Total Cost”. In this instance, upon actuating the “Annual Routine” button 731, the information from data base 530 “Data from Specification Table/Customer's Building” in the form of a matrix shown in FIG. 20 is provided on the screen of the buyer's computer 14. This matrix presents the Specification Table created as a result of cross-referencing the information input during the processing procedures of FIGS. 4 and 7, i.e., based on the actual inputs of the buyer as described in previous paragraphs, i.e., the room type, floor type, square footage, etc. from data bases created at the “Customer Information” and “Default Building Administration” branches of the overall procedure.

In the matrix shown in FIG. 20, the pull-down 732 automatically sets quality ratings based on the data from the table 715 of FIG. 14. In the grid 733, the data is presented from the screens of FIGS. 6 and 9.

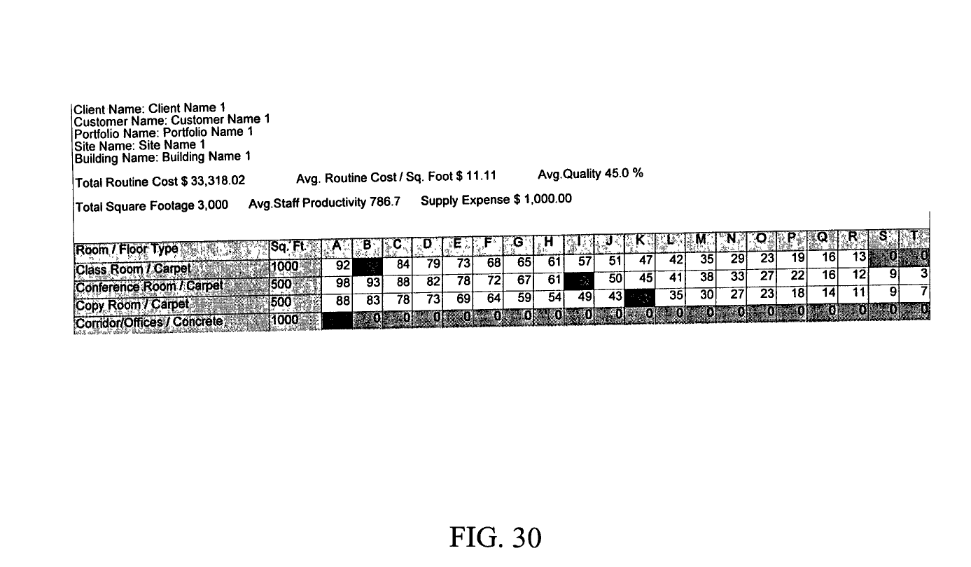

Data presented on the bottom of the screen shown in the FIG. 20, i.e., total routine cost, total square footage, average cost/square feet, average staff productivity, average quality and supply expense are not editable and are calculated by the software of the present invention as will be described herein in further paragraphs. Upon completing the block 540, the logic flows to block 550 of FIG. 8, in order that the buyer can print out a matrix grid shown in FIG. 30 by actuating the button 734 “Print Matrix” on the screen of the FIG. 20.

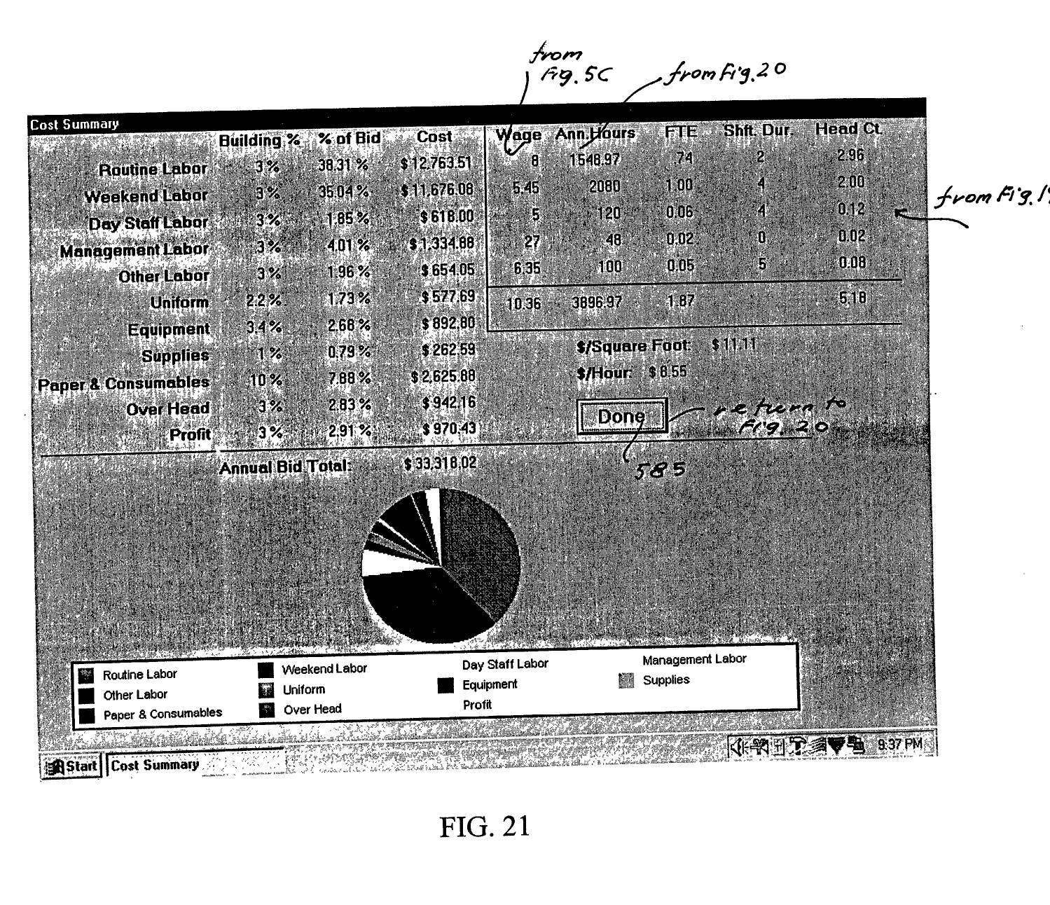

If the “Cost Summary” button 545 is actuated, the logic flows from the block 540 to the block 560 “Show on Screen Summary of Matrix Labor Figures” which is shown in the FIG. 11 and which represents a summary showing the percent of a routine and non-routine labor, as well as the percent of other expenses, to the actual cost of the bid. If in this instance the “Done” button 585 on the screen of the FIG. 21 corresponding also to the “Done” button 585 of the flow chart shown in FIG. 8, is actuated, the logic returns to the screen shown in the FIG. 20. If the “Done” button 565 (corresponding also to the “done” button of the flow-chart shown in FIG. 8) is actuated, the information is stored in data base 600 and the logic returns to the main menu 40 in FIG. 3.

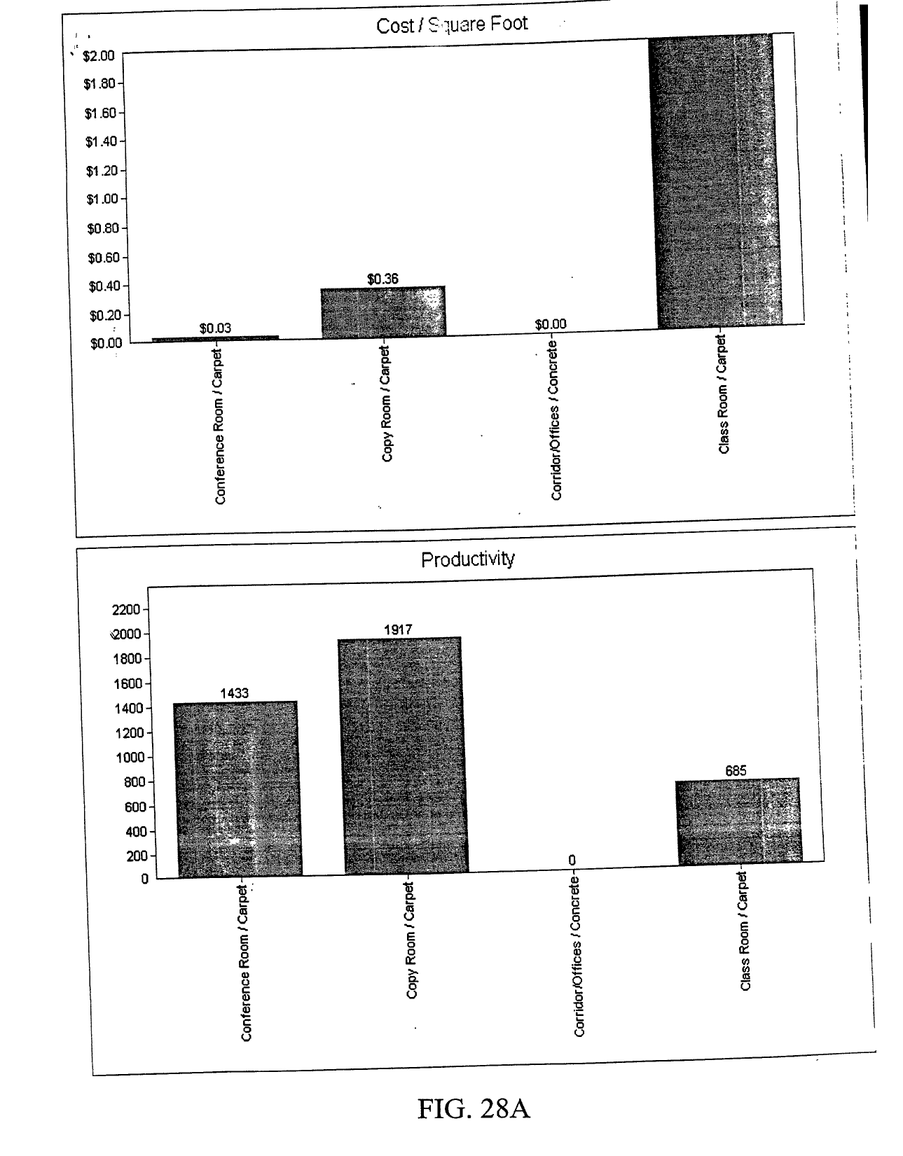

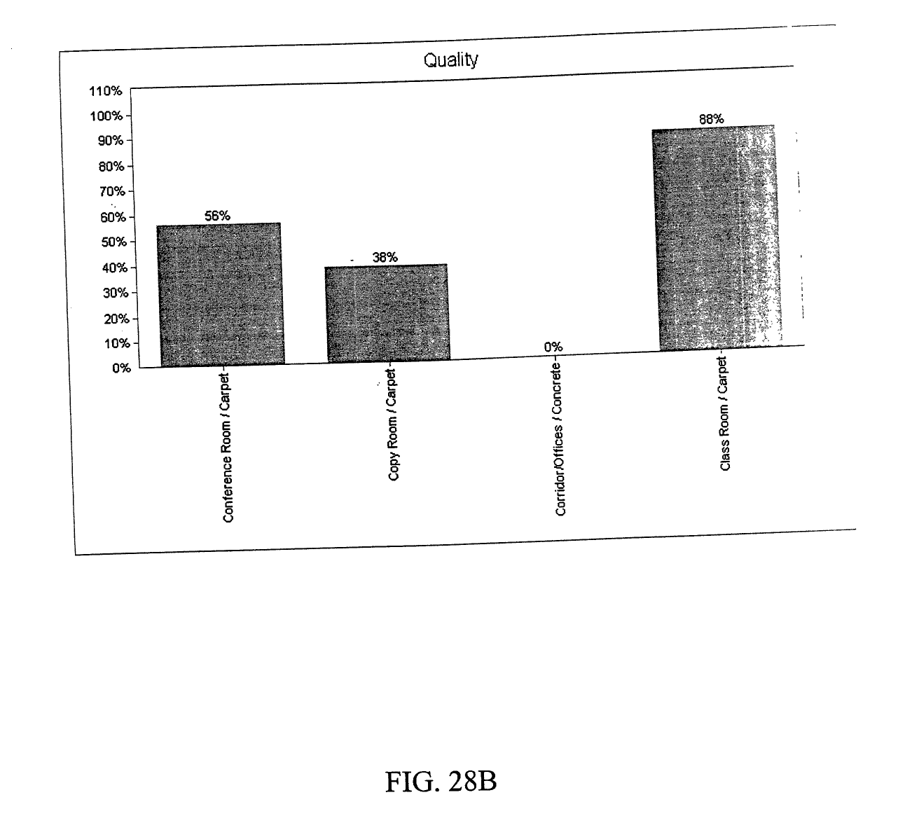

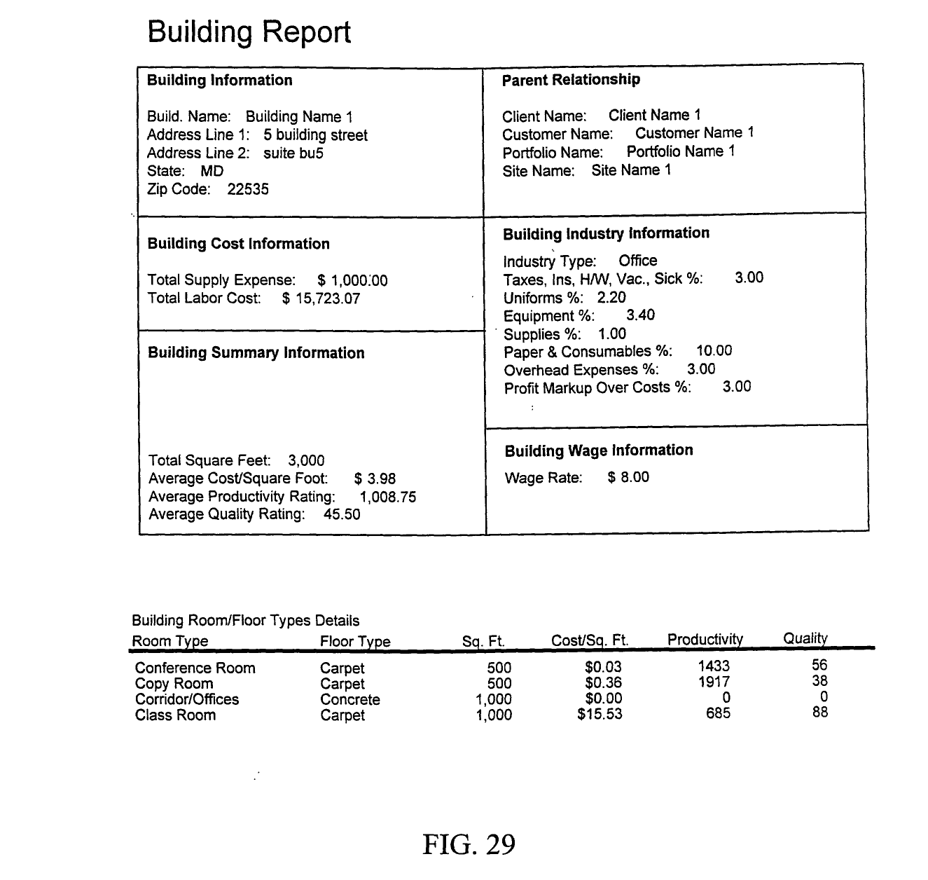

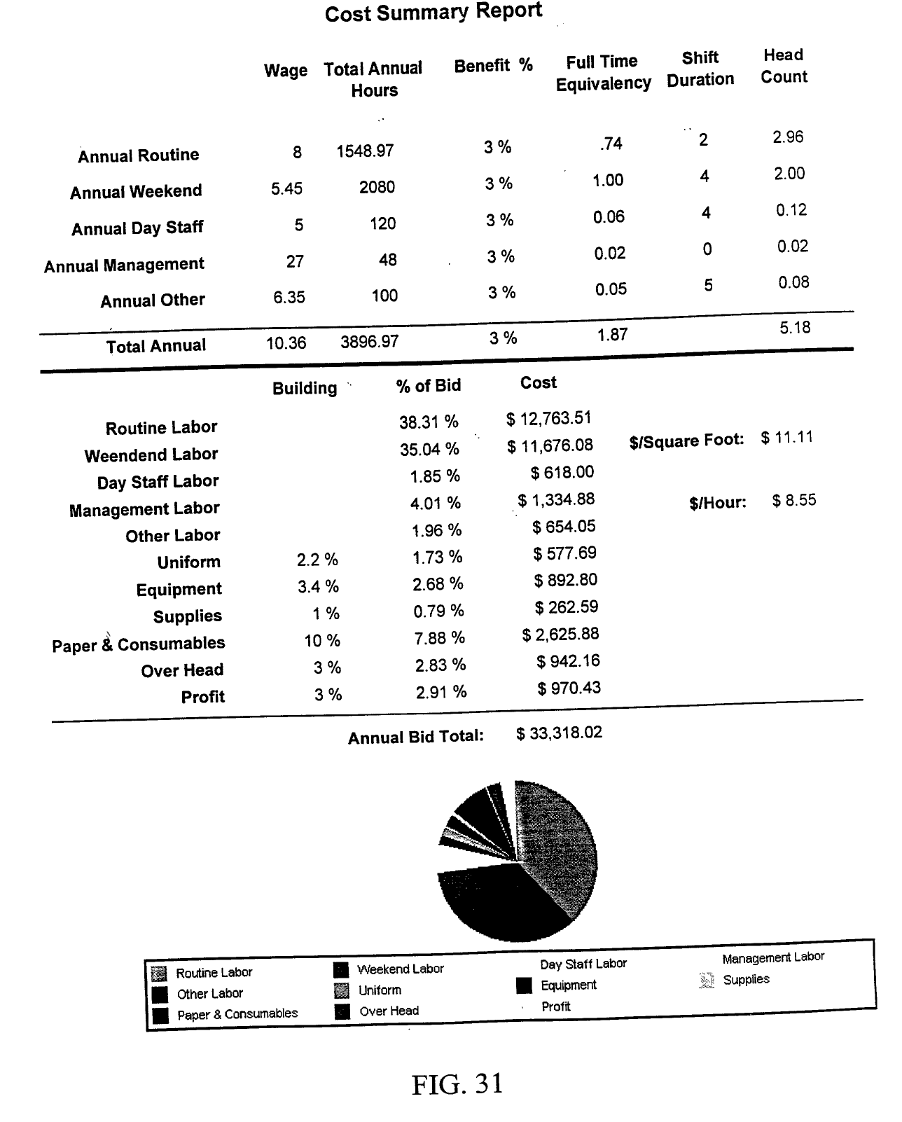

If the “Print Reports” button 575 is actuated as shown both in FIGS. 8 and 20, the selected desired reports are insert to the screen in the block 570 for being further printed in the blocks 580. These reports may include cost summary report, building specific reports, the building summary, a list of all the rooms of the building, the cleaning specifications, shown in FIGS. 27A-27C, 28A-B, FIG. 29 and FIG. 31.

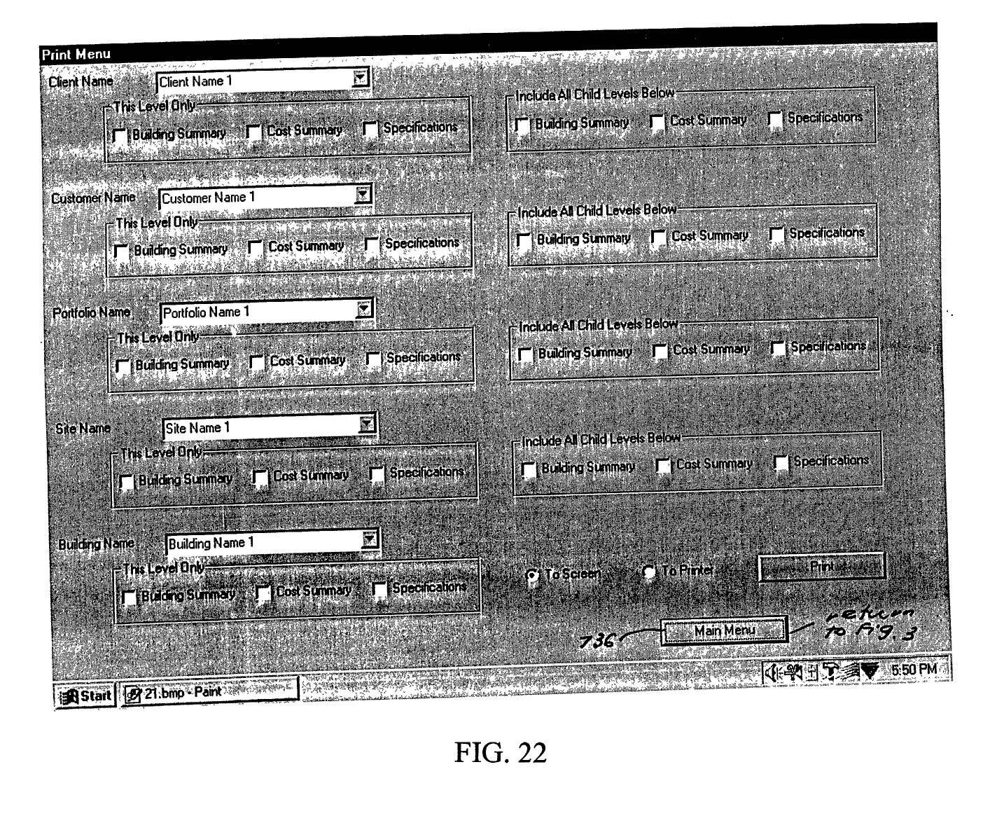

After the portions 50, 52, 55, 57 and 60 of the main menu 40 have been completed, the buyer may actuate the “Print Menu” box 65 of the main menu 40 shown in FIG. 3, in order that the logic pulls on the display of the buyer's computer screen shown in FIG. 22. This portion of the software is controlled by the logic blocks 570, 580, and 590 of the flow-chart diagram shown in FIG. 8. In the screen of the FIG. 22, the buyer may select pull-downs of respective information levels, such as client, customer, portfolio, site and building, and with respect to each level, the buyer can choose a particular report (or reports) to be printed (in the logic block 570), as well as to address the reports either to the screen (logic block 580) or to the printer 52 (logic block 590). Upon completion the “Print Menu” of the FIG. 22, the buyer may return to the main menu of FIG. 3 by actuating “Main Menu” button 736.

Upon completing all parts of the main menu 40 (FIG. 3), the logic flows from the block 65 to the block 70 “Exit” and the main menu 40 disappears from the screen of the computer 14 and the buyer is returned to the Windows format.

The software of the present invention, as a portion of its operation, carries out rather extensive calculation as follows:

a) regarding the data presented in the Cost Summary (FIG. 22):

Routine labor(C1)=the total of (each room/floor/quality ratings annual hours*sq-foot for that room/floor*wage rate/1000)*(1+P1 from FIG. 5C) (1)

where P1 is the data shown in “Taxes, Ins, H/W, Vac, Sick” icon.

### EXAMPLE

first room/floor listed in FIG. 20:

Class room/carpet 88% (B) highlighted.

It corresponds to the data from FIG. 9, shown in the row 740: class room/carpet version code (B), performance quality 88, the annual hours—1530. The square foot for the data of the row 740 will then be found in the FIG. 20 to be equal 1000. The wage rate for that building which can be found in FIG. 6 is $8.00. Then, assigning the aforesaid values to the formula (1), the calculation will result in

$$class / room / floor = \frac{1530 * 1000 * \text{\$8.00}}{1000} = \text{\$12,240.00}$$

As it is noticed in FIG. 5C, the P1=3% (or 0.03).

Similarly, for room/floor type of FIG. 20:

$$Conference room / carpet = \frac{2.93 * 500 * \$8 .00}{1000} = \$11 .76$$

$$Copy room / carpet = \frac{35 * 500 * \$8 .00}{1000} = \$140 .00$$

$$Corridor / offices / concrete = \frac{0 * 1000 * \$8 .00}{1000} = \frac{\$ 0.00}{}$$

$$Total \text{\$12,391.76} = x 3$$

Thus the routine labor is shown in FIG. 21: $12,391.76*1.03=$12,763.51.

To calculate weekend labor (FIG. 21), the following formula is used:

annual weekend wage*total annual hours*(1+P1 from screen) (2)

Assigning data from FIG. 19 to the formula (2), the weekend labor (C2) 5.45*2080*$1.03)=$11,676.08.

Pay staff labor of the Cost summary (FIG. 21) is calculated by assigning data from the Appendix C to the following formula (3):

wage*total annual hours*(1+P1 from FIG. 5C) (3)

The calculation will result in day staff labor (C3)=5*120*(1.03)=$618.00.

Management labor of the cost summary (FIG. 21) is calculated by assigning data from the FIG. 19 to the following formula (4):

Management Labor (C4)=wage*total annual hours*(1+P1) (4).

The calculation will result in:

Management Labor (C4)=27*48*(1.03)=$1,334.88. Other labor (C5)=wage*total annual hours*(1+P1) (5).

Assigning the data from the FIG. 19 to the formula (5), will result in 6.35*100*(1.03)=$654.05.

For the uniform, equipment, supplies, paper and consumables, a variable called “total labor” has been calculated:

total labor=X3 (which is routine wage*total annual hours)+(weekend wage*total annual hours)+(day staff wage*total annual hours)+(management wage*total annual hours)+(other wage*total annual hours) (6).

The needed information for the formula (6) is obtained from the chart in the upper right hand corner of the FIG. 21.

Then: total labor=(8*1548.97)+(5.45*2080)+(5*120)+(27*48)+(6.35*100)=$26,258.76.

In view of this, for the Cost Summary:

uniform (C6)=total labor*P2,

where P2 is obtained from “Uniforms” icon of FIG. 5C.

Then: Uniforms (C6)=$26,258.76*0.22−$577.69.

Equipment (C7)=total labor*P3,

wherein P3 is obtained from the Equipment” icon of FIG. 5C.

Then, equipment (C7)=$26,258.76*.034=492.80.

Supplies (C8)=total labor*P4,

wherein P4 is obtained from “Supplies” icon of FIG. 5C.

Then, supplies (C8)−$26,258.76*.01=$262.59.

Paper & Consumables−total labor*P5

wherein P5 is obtained from the respective icon of FIG. 5C.

Then, paper and consumables (C9)=$2,625.88.

Overhead (C10)=(C1+C2+C3+C4+C5+C6+C7+C8+C9)*P6

wherein P6 is obtained from the “Overhead Expenses” icon of FIG. 5C

Then, Overhead (C10)=$942.16.

Profit (C11)=(C1+C2+ . . . +C10)*P7

wherein P7 is obtained from the profit mark-up icon of FIG. 5C.

Then, Profit (C11)=$970.43

Annual bid total (C12)=(C1+C2+C3+C4+C5+C6+C7+C8+C9+C10+C11) C12=$33,318.02.

With respect to the parameters of the FIG. 20, such as total routine cost, total square footage, avg. cost/sq. foot, and staff productivity, avg. quality, and supply expense, the total routine cost is obtained from C12 of FIG. 21.

Total square footage=sum of all sq footages from the “Customer Building Characteristics” table 706 of FIG. 6.

Avg. cost/sq foot=total routine cost/total square footage.

Avg. staff productivity=weighted average of room/floor/quality numbers obtained from the FIG. 14.

Avg. quality=weighted average of room/floor/quality number selected from above.

Supply expense is obtained directly from FIG. 6.

Regarding data presented in FIG. 19:

FTE—total annual hours/2080

head count—FTE*8/shift duration

ie FTE*8/shift duration=0.06*8/4=0.12

Thus, using the information provided by the buyer, in combination with the proprietary data pre-stored in the system of the present invention as well as the data base related to standard maintenance, repair and operation parameters, the system shown in FIGS. 3-22, processes all of the data, calculates the buyer's request, and generates a complete request for proposal which is further submitted to providers of maintenance, repair and operation services as discussed in previous paragraphs.

It is to be understood that the present invention as described in previous paragraphs is not only the system and matrix method of computerized maintenance, repair and operation services acquisition but is also intended as a method of doing business in maintenance, repair and operation industry permitting dramatically decreased cost and time consumption of the maintenance, repair and operation services acquisition process. In accordance with the method of doing business of the present invention,

(a) the processor 12 is accessed by a remote buyer of maintenance, repair and operation services over a communication channel (Internet),

(b) the buyer inputs into the processor, specific buyer's data,

(c) the processor calculates the buyer's requirements;

(d) the processor generates a request for proposal, and

(e) the processor transmits the request for proposal to the buyer for further use by the buyer for acquisition of maintenance, repair and operation services from a maintenance, repair and operation services provider.

Although this invention has been described in connection with specific forms and embodiments thereof, it will be appreciated that various modifications other than those discussed above may be resorted to without departing from the spirit or scope of the invention. For example, equivalent elements may be substituted for those specifically shown and described, certain features may be used independently of other features, and in certain cases, particular locations of elements may be reversed or interposed, all without departing from the spirit or scope of the invention as defined in the appended Claims.

What is claimed is:

1. A maintenance, repair and operation services system, comprising:
processor means, and
means for coupling said processor means to a remote buyer of maintenance, repair and operation services;
said processor means including:
means for storing standard maintenance, repair and operation parameters,
means for requesting and receiving through said coupling means specific buyer data from said buyer,
means for processing said specific buyer data in said processor means and calculating buyer's requirements responsive to said specific buyer data input and in view of said standard maintenance, repair and operation parameters,
means for generating buyer's request for proposal, and
means for transmitting said buyer's request for proposal from said procedure means to said buyer through said coupling means.

2. The maintenance, repair and operation services system of claim 1 further comprising means for printing out said buyer's request for proposal.

3. The maintenance, repair and operation services system of claim 1 further comprising means for coupling said processor means to at least one maintenance, repair and operation services provider,
means for transmitting said buyer's request for proposal to said at least one maintenance, repair and operation services provider, and
means for receiving into said processor means proposal information from said at least one maintenance, repair and operation services provider in response to said buyer's request for proposal.

4. The maintenance, repair and operation services system of claim 1, wherein said standard maintenance, repair and operation parameters includes either of statistics data related to the buyer's building, local labor rates, costs for uniforms, costs for equipment, costs for supplies, paper costs, overhead expenses, and profit mark-ups.

5. The maintenance, repair and operation services system of claim 1, wherein said specific buyer data includes either of:
name of the buyer,
address of the building,
building details,
the industry within which the building is affiliated,
square footage of the building,
square footage of the area to be cleaned,
breakdown for each type of space in the building,
type of floor covering,
level of cleaning, and
frequency of the cleaning.

6. The maintenance, repair and operation services system of claim 1, wherein said standard maintenance, repair and operation parameters are entered into said processor means by said buyer.

7. The maintenance, repair and operation services system of claim 1, wherein said standard maintenance, repair and operation parameters are available to said buyer from said storing means of said processor means.

8. The maintenance, repair and operation services system of claim 1, wherein said requesting and receiving means further comprises means for requesting and receiving from said buyer labor rates in said building.

9. A matrix method for generating a request for proposal for maintenance, repair and operation services, comprising the steps of:
coupling a processor to a remote buyer of maintenance, repair and operation services through a communication channel,
storing in said processor standard maintenance, repair and operation parameters,
requesting and receiving at said processor specific buyer data from said buyer through said communication channel,
processing said specific buyer data in said processor,
calculating buyer's requirements responsive to said specific buyer data input and in view of said standard maintenance, repair and operation parameters,
generating at said processor buyer's request for proposal, and
transmitting said buyer's request for proposal to said buyer through said communication channel.

10. The matrix method of claim 9, further comprising the steps of:
printing out said buyer's request for proposal.

11. The matrix method of claim 10, further comprising the steps of:
printing out a specific part of said buyer's request for proposal upon said buyer's command.

12. The matrix method of claim 9, further comprising the steps of:
coupling at least one provider of maintenance, repair and operation services to said processor,
transmitting said buyer's request for proposal from said processor to said at least one provider of maintenance, repair and operation services, and
receiving at said processor proposal information from said at least one provider of maintenance, repair and operation services in response to said buyer's request for proposal.

13. The matrix method of claim 9, further comprising the steps of:
requesting said standard maintenance, repair and operation parameters from said buyer.

14. The matrix method of claim 9, further comprising the steps of:
providing said standard maintenance, repair and operation parameters to said buyer from said processor.

15. The matrix method of claim 9, wherein said standard maintenance, repair and operation parameters include either of: statistics data related to said buyer's building, local labor rates, costs for uniforms, equipment, supplies, paper, overhead expenses, and profit mark-ups.

16. The matrix method of claim 9 further comprising the steps of:
requesting and receiving from said buyer at said processor said specific buyer data including labor rates in said buyer's building.

17. The matrix method of claim 16, further comprising the steps of:
requesting and receiving from said buyer at said processor either of:
name of said buyer,
address of said buyer's building,
said building details,
the industry within which said building is affiliated,
square footage of said building,
square footage of the area to be cleaned in said building,
breakdown for each type space in said building,
type of floor covering,
level of cleaning, and
frequency of cleaning.

18. A matrix method of doing business in maintenance, repair and operation industry, comprising the steps of:
providing processor accessible by a remote buyer of maintenance, repair and operation services over a communication channel extending between said processor and said buyer of maintenance, repair and operation services,
generating, by said processor, a request for proposal of maintenance, repair and operation services upon receiving at said processor of requested specific buyer data from said buyer of maintenance, repair and operation services, and
transmitting said request for proposal from said processor to said buyer of maintenance, repair and operation services over said communication channel for further use by said buyer of maintenance, repair and operation services in pursuit for acquisition of maintenance, repair and operation services from a maintenance, repair and operation services provider.

19. The matrix method of doing business of claim 18, further comprising the steps of:
storing standard maintenance, repair and operation parameters,
processing said specific buyer data,
calculating buyer's requirements responsive to said specific buyer data input and in view of said standard maintenance, repair and operation parameters, and
constructing said request for proposal based on said buyer's requirements.

20. The matrix method of doing business of claim 18, further comprising the steps of:
coupling said buyer of maintenance, repair and operation services with at least one maintenance, repair and operation services provider through said processor,
transmitting said request for proposal to said at least one maintenance, repair and operation services provider, and
receiving at said processor proposal information from said at least one maintenance, repair and operation services provider in response to said buyer's request for proposal for said buyer's consideration.
